(19) United States
(12) Patent Application Publication
(10) Pub. No.: US 2026/0188347 A1
(43) Pub. Date: Jul. 2, 2026

(54) MAGNETIC DISK DEVICE AND METHOD

(71) Applicants: Kabushiki Kaisha Toshiba, Kawasaki-shi (JP); Toshiba Electronic Devices & Storage Corporation, Kawasaki-shi (JP)

(72) Inventor: Tomokazu OKUBO, Saitama Saitama (JP)

(21) Appl. No.: 19/430,841

(22) Filed: Dec. 23, 2025

(30) Foreign Application Priority Data
Dec. 27, 2024 (JP) 2024-232874
Dec. 2, 2025 (JP) 2025-218953

(51) Int. Cl. G11B 5/02; G11B 5/00; G11B 5/012

(52) U.S. Cl. CPC G11B 5/02; G11B 5/012; G11B 2005/0005

(57) ABSTRACT

According to an embodiment, a magnetic head includes a write element and a light emitting element that irradiates a write position by the write element with laser light. A processing circuit can execute any write operation of a first write operation of supplying a positive recording current with an amplitude of a fourth value to the write element during output of the laser light, a second write operation of supplying a negative recording current having an amplitude of a fifth value to the write element during output of the laser light, and a third write operation of supplying a recording current including a recording current having an amplitude of a sixth value to the write element, the sixth value being a non-zero value smaller than those of both the fourth value and the fifth value, during output of the laser light.

### CROSS-REFERENCE TO RELATED APPLICATIONS

This application is based upon and claims the benefit of priority from Japanese Patent Application No. 2024-232874, filed on Dec. 27, 2024, and Japanese Patent Application No. 2025-218953, filed on Dec. 2, 2025; the entire contents of all of which are incorporated herein by reference.

### FIELD

Embodiments described herein relate generally to a magnetic disk device and a method.

### BACKGROUND

In recent years, technology for writing a signal that can take three or more levels to a magnetic disk has been developed.

### BRIEF DESCRIPTION OF THE DRAWINGS

FIG. 1 is a diagram illustrating an exemplary configuration of a magnetic disk device according to a first embodiment;

FIG. 2 is a schematic diagram illustrating an exemplary configuration of a magnetic disk according to the first embodiment;

FIG. 3 is a graph showing an exemplary relationship between the amplitude of a recording current corresponding to a 0 state and the bit error rate when reading is performed on a digit region in the 0 state;

FIG. 4 is a diagram illustrating an example of a detailed configuration of a processing circuit according to the first embodiment;

FIG. 5 is a diagram for describing a specific example of a recording method according to the first embodiment;

FIG. 6 is a diagram for describing a specific example of a recording method according to a first modification;

FIG. 7 is a diagram for describing a specific example of a recording method according to a second modification;

FIG. 8 is a diagram illustrating an example of a detailed configuration of a processing circuit to which a PBW method is applied according to a third modification;

FIG. 9 is a diagram for describing a specific example of a recording method to which the PBW method is applied according to the third modification;

FIG. 10 is a diagram illustrating an example of a detailed configuration of a processing circuit to which an MPRZ method is applied according to the third modification;

FIG. 11 is a diagram for describing a specific example of a recording method to which an NPRZ method is applied according to the third modification;

FIG. 12 is a diagram illustrating an example of a detailed configuration of a processing circuit to which the MPRZ method is applied according to a fourth modification;

FIG. 13 is a diagram for describing a specific example of a recording method according to the fourth modification;

FIG. 14 is a diagram for describing a specific example of a recording method according to a fifth modification;

FIG. 15 is a graph showing, for each of a case where the data length of “0” to be written is 1T and a case where the data length of “0” to be written is 2T, the relationship between the laser drive current at the time of writing “0” and the fluctuation in the amplitude of a reproduction signal when reading is performed on a large number of digit regions where “0” is written;

FIG. 16 is a diagram for describing a specific example of a recording method according to a second embodiment;

FIG. 17 is a graph showing, for each of a case where the length of pre-written data is 2T and a case where the length of pre-written data is 6T, the relationship between the laser drive current at the time of writing “0” and the fluctuation in the amplitude of a reproduction signal when reading is performed on a large number of digit regions where “0” is written;

FIG. 18 is a diagram for describing a specific example of a recording method according to a third embodiment;

FIG. 19 is a diagram for describing a specific example of the recording method according to the third embodiment;

FIG. 20 is a diagram for describing a specific example of a recording method according to a sixth modification;

FIG. 21 is a diagram for describing another specific example of the recording method according to the sixth modification;

FIG. 22 is a diagram for describing a specific example of a recording method according to a seventh modification; and

FIG. 23 is a diagram for describing an example of a configuration for implementing a recording method according to the seventh modification.

### DETAILED DESCRIPTION

According to the present embodiment, a magnetic disk device includes a magnetic disk, a magnetic head, and a processing circuit. The magnetic disk includes a track including a plurality of unit recording regions arranged in a line in a circumferential direction. The magnetic head includes a write element that writes data to a track and a light emitting element that irradiates a write position by the write element on the magnetic disk with laser light. The processing circuit can execute any write operation of a first write operation of writing a first value in a first unit recording region, a second write operation of writing a second value in the first unit recording region, and a third write operation of writing a third value in the first unit recording region. The first unit recording region is one unit recording region among the plurality of unit recording regions. The second value is different from the first value. The third value is different from both the first value and the second value. The first write operation is an operation of bringing the magnetization state of the first unit recording region into a first state by supplying a positive recording current having an amplitude of a fourth value to the write element while causing the light emitting element to output laser light. The second write operation is an operation of bringing the magnetization state of the first unit recording region into a second state which is different from the first state by supplying a negative recording current having an amplitude of a fifth value to the write element while causing the light emitting element to output laser light. The third write operation is an operation of bringing the magnetization state of the first unit recording region into a third state which is different from both the first state and the second state by supplying a recording current including a recording current having an amplitude of a sixth value to the write element, the sixth value being a non-zero value smaller than those of both the fourth value and the fifth value, while causing the light emitting element to output laser light.

Hereinafter, a magnetic disk device and a method according to embodiments will be described in detail with reference to the accompanying drawings. Note that the present invention is not limited by these embodiments.

### First Embodiment

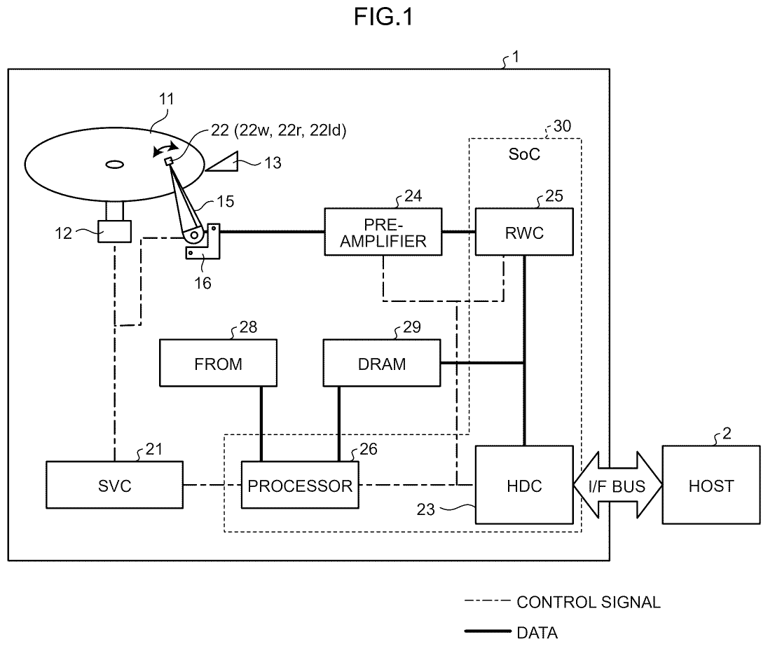

FIG. 1 is a diagram illustrating an exemplary configuration of a magnetic disk device 1 according to a first embodiment.

The magnetic disk device 1 is connected to a host 2. The magnetic disk device 1 can receive an access command such as a write command or a read command from the host 2.

The magnetic disk device 1 includes a magnetic disk 11 having a magnetic layer formed on a surface thereof. The magnetic disk device 1 accesses the magnetic disk 11 in response to the access command. The access includes writing of data and reading of data. Note that although the magnetic disk device 1 can include a plurality of magnetic disks 11, in the first embodiment, the magnetic disk device 1 includes one magnetic disk 11 for the sake of simplicity of description and illustration.

Data is written and read via a magnetic head 22. Specifically, in addition to the magnetic disk 11, the magnetic disk device 1 includes a spindle motor (SPM) 12, a ramp 13, an actuator arm 15, a voice coil motor (VCM) 16, a servo controller (SVC) 21, the magnetic head 22, a hard disk controller (HDC) 23, a preamplifier 24, a read and write channel (RWC) 25, a processor 26, a flash read only memory (FROM) 28, and a dynamic random access memory (DRAM) 29.

The magnetic disk 11 is rotated at a predetermined rotation speed by the SPM 12 attached coaxially.

The SVC 21 is an integrated circuit having a function as a driver that drives the SPM 12 and the VCM 16. The processor 26 controls the rotation of the SPM 12 and the rotation of the VCM 16 via the SVC 21.

The magnetic head 22 includes a write element 22w and a read element 22r. The magnetic head 22 writes data to the magnetic disk 11 by the write element 22w. The magnetic head 22 reads data from the magnetic disk 11 by the read element 22r.

The magnetic head 22 further includes a laser diode 22ld. When data is written by the write element 22w, the laser diode 22ld locally heats the write position by irradiating the write position for the write element 22w on a surface of the magnetic disk 11 with laser light such as near-field light. As a result, the coercive force at the write position decreases, whereby the amount of a current for generating the magnetic field (hereinafter, referred to as the recording current) that is supplied to the write element 22w can be reduced. Such a recording method for assisting magnetization by thermal energy is known as a heat assisted magnetic recording (HAMR) method. That is, according to the embodiment, writing by the heat assisted magnetic recording method is performed by the laser diode 22ld.

Note that the laser diode 22ld is an example of the light emitting element. The light emitting element is not limited to a laser diode as long as thermal energy can be applied to the write position by irradiating the write position with laser light.

The magnetic head 22 is attached to the tip of the actuator arm 15. The magnetic head 22 is moved in the radial direction of the magnetic disk 11 by the VCM 16 driven by the SVC 21. Note that, as for the write element 22w and the read element 22r included in the magnetic head 22, a single magnetic head 22 may include a plurality of write elements 22w and/or read elements 22r.

In such cases where the rotation of the magnetic disk 11 is stopped, the magnetic head 22 is moved to the ramp 13. The ramp 13 holds the magnetic head 22 at a position away from the magnetic disk 11.

The preamplifier 24 is an integrated circuit that writes and reads data via the magnetic head 22. During a write operation, the preamplifier 24 amplifies a signal corresponding to data to be written (write data signal described later) that is supplied from the RWC 25 and supplies the amplified signal to the write element 22w. Furthermore, during the write operation, the preamplifier 24 controls output of laser light of the laser diode 22ld on the basis of a signal supplied from the RWC 25 (laser control signal described later). During a read operation, the preamplifier 24 amplifies a reproduction signal sent from the read element 22r and supplies the amplified signal to the RWC 25.

The DRAM 29 is used as a buffer for data transferred to and from the host 2. For example, the DRAM 29 is used to temporarily store data to be written or data read from the magnetic disk 11.

The DRAM 29 is used as an operation memory by the processor 26. The DRAM 29 is used as a region in which a firmware program is loaded and a region in which various types of management data are temporarily stored.

The HDC 23 executes control of data transfer with the host 2 via an I/F bus. The HDC 23 supplies data to be written and is received from the host 2 to the RWC 25 via the DRAM 29. The HDC 23 receives read data output from the RWC 25 via the DRAM 29 and transmits the read data to the host 2.

The RWC 25 modulates data to be written that is supplied from the HDC 23 and supplies the data to the preamplifier 24. The RWC 25 also performs demodulation including error correction on a signal read from the magnetic disk 11 and supplied from the preamplifier 24 and then outputs the signal to the HDC 23 as digital data.

The processor 26 is, for example, a central processing unit (CPU). The processor 26 is connected with the FROM 28 and the DRAM 29.

The FROM 28 stores the firmware program, various types of setting information, and others. Note that the firmware program may be stored on the magnetic disk 11.

The processor 26 performs overall control of the magnetic disk device 1 in accordance with the firmware program stored in the FROM 28 or the magnetic disk 11.

The HDC 23, the RWC 25, and the processor 26 can be configured as a system-on-a-chip (SoC) 30. In addition to these, the SoC 30 may include other elements (such as the FROM 28 or the DRAM 29).

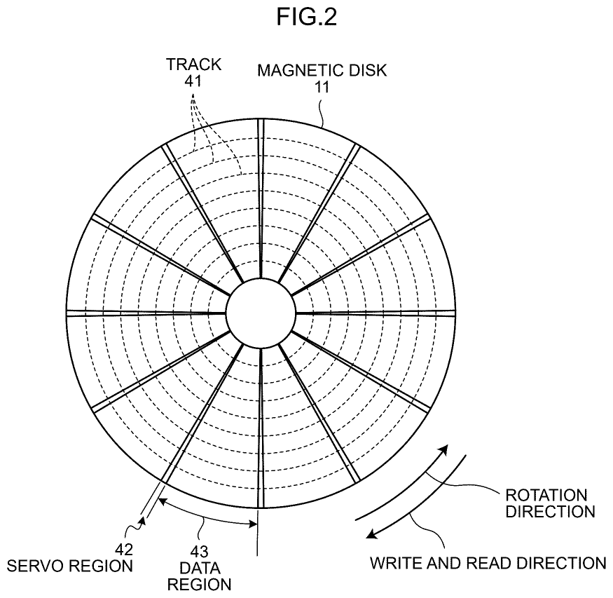

FIG. 2 is a schematic diagram illustrating an exemplary configuration of the magnetic disk 11 according to the first embodiment. Illustrated in this drawing is an example of the rotation direction of the magnetic disk 11. The magnetic head 22 moves relative to the magnetic disk 11 by the rotation of the magnetic disk 11. Therefore, a write and read direction, namely, a direction in which data is written or read by the magnetic head 22 in the circumferential direction is opposite to the rotation direction of the magnetic disk 11.

Servo information is written to the magnetic disk 11 by, for example, a servo writer or self-servo write (SSW) in the manufacturing process. Illustrated in FIG. 2 are servo regions 42 radially arranged as an example of arrangement of servo regions in which the servo information is written. Data regions 43 in which data can be written are included between the servo regions 42.

A plurality of concentric tracks 41 is set in the radial direction of the magnetic disk 11. A plurality of sectors in which data is written is arranged in a plurality of data regions 43 arranged along the tracks 41.

The servo information includes a servo mark, a gray code, a burst pattern, and a post code. When writing data to a sector or reading data from a sector, the SoC 30 acquires information about the current position of the magnetic head 22 on the basis of servo information read from a servo region 42 by the magnetic head 22. Then, the SoC 30 executes positioning control to bring the magnetic head 22 closer to a target position on the basis of information of the current position obtained by calculation.

Data can be deemed as a sequence of a plurality of values. In each track 41 (more precisely, each sector of each track 41), a sequence including a plurality of 1-digit values is written along the track 41. That is, each track 41 (more precisely, each sector of each track 41) can be conceived to have a structure in which a plurality of unit recording regions each capable of holding a single-digit value is arranged in a line along the track 41. A unit recording region capable of holding the single-digit value is referred to as a digit region.

In the first embodiment, a signal that can take three levels is recorded in the digit region. That is, a single-digit value expressed in the ternary is written in each digit region.

Specifically, in the write operation, the write element 22w is controlled as follows. When a positive recording current having an amplitude greater than or equal to a predetermined value is supplied in a state where a digit region where the write element 22w is located is irradiated with laser light, the write element 22w generates a magnetic field corresponding to the recording current, thereby magnetizing the digit region where the write element 22w is located to positive polarity. When a negative recording current having an amplitude greater than or equal to the predetermined value is supplied in a state where a digit region where the write element 22w is located is irradiated with laser light, the write element 22w generates a magnetic field corresponding to the recording current, thereby magnetizing the digit region where the write element 22w is located to negative polarity.

Furthermore, in the write operation, when the amplitude of the recording current is suppressed to substantially zero in a state where the digit region where the write element 22w is located is irradiated with laser light, the write element 22w makes the polarity of magnetization of the digit region where the write element 22w is located nonpolar. This is based on the fact that, in the case where only thermal energy is applied such that the temperature of the digit region is higher than or equal to the Curie temperature in a state where no magnetic field is applied, the polarity of magnetization of a large number of magnetic particles in the digit region randomly fluctuates, whereby the polarity of magnetization of the entire digit region is apparently observed as being nonpolar.

As described above, the digit region is magnetized to any one of positive polarity, negative polarity, or non-polarity by the write operation. Different values are respectively associated with the magnetization states of a digit region, namely, the positive polarity state, the negative polarity state, and the nonpolar state.

In the read operation, when the read element 22r passes over a digit region, a reproduction signal having an amplitude corresponding to the polarity of magnetization of the digit region is obtained by the read element 22r. In a case where the polarity of magnetization of the digit region is positive, a reproduction signal with an amplitude of a positive predetermined value is obtained. In a case where the polarity of magnetization of the digit region is negative, a reproduction signal with an amplitude of a negative predetermined value is obtained. In a case where the polarity of magnetization of the digit region is negative, a reproduction signal with a zero amplitude is obtained. The RWC 25 acquires a value corresponding to the magnetization state of the digit region on the basis of the amplitude of the reproduction signal obtained from the read element 22r.

The correspondence relationship between the magnetization state and the value is designed as desired. Hereinafter, as an example, it is based on the premise that “+1” is associated with the positive polarity state, “−1” is associated with the negative polarity state, and “0” is associated with the nonpolar state. The positive polarity state, namely, a state in which “+1” is written is referred to as a +1 state. The negative polarity state, namely, a state in which “−1” is written is referred to as a −1 state. The nonpolar state, namely, a state in which “0” is written is referred to as a 0 state.

Furthermore, the amplitude of the recording current for setting a digit region to the +1 state is expressed as the amplitude of the recording current corresponding to the +1 state. The amplitude of the recording current for setting a digit region to the −1 state is expressed as the amplitude of the recording current corresponding to the −1 state. The amplitude of the recording current for setting a digit region to the 0 state is expressed as the amplitude of the recording current corresponding to the 0 state.

In a case where the correspondence relationship between the magnetization state and the value is determined as described above, “+1” is an example of the first value. The value “−1” is an example of the second value. The value “0” is an example of the third value. An operation to write “+1” in the digit region is an example of the first write operation. An operation to write “−1” in the digit region is an example of the second write operation. An operation to write “0” in the digit region is an example of the third write operation. The value of the amplitude of the recording current for setting a digit region to the +1 state (AW1 described later) is an example of the fourth value. The value of the amplitude of the recording current for setting a digit region to the +1 state (AW2 described later) is an example of the fifth value. The value of the amplitude of the recording current for setting a digit region to the 0 state (AW3 described later) is an example of the sixth value. The positive polarity is an example of the first state. The negative polarity is an example of the second state. The non-polarity is an example of the third state.

In the write operation, if the amplitude of the recording current corresponding to the 0 state is set exactly to zero, the magnetization state of a target digit region is determined depending on thermal noise or an induced magnetic field from surrounding digit regions. As a result, a polarity bias occurs in the magnetization of a large number of magnetic particles in the target digit region. Since this bias occurs randomly for each digit region, the amplitude of the reproduction signal as of the time when reading is performed on a large number of 0-state digit regions fluctuates, and the bit error rate deteriorates depending on the fluctuation.

Therefore, in the first embodiment, the amplitude of the recording current corresponding to the 0 state is controlled to minute value which is not zero. As a result, the polarity bias is intentionally suppressed in the magnetization of the large number of magnetic particles in the target digit region, whereby the fluctuation in the amplitude of the reproduction signal at the time of reading from the digit region in the 0 state is suppressed.

Note that, as a matter of course, if the amplitude of the recording current corresponding to the 0 state is too large, the recording method of the 0 state becomes equivalent to the normal saturation magnetic recording, namely, a recording method in which almost all magnetic particles included in the digit region are set to either the positive polarity or the negative polarity. Therefore, the amplitude of the recording current corresponding to the 0 state needs to have a sufficiently small value with respect to that of the amplitude of the recording current corresponding to the −1 state or the +1 state.

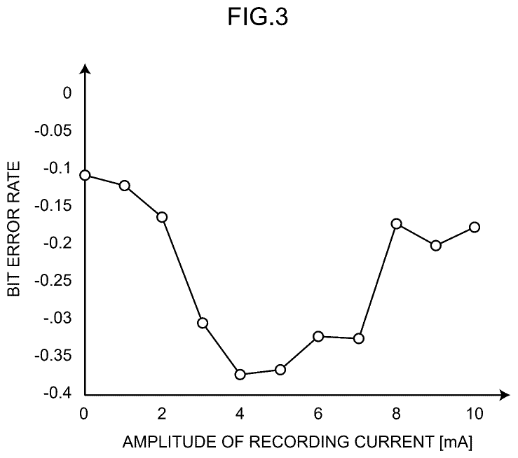

FIG. 3 is a graph showing an exemplary relationship between the amplitude of a recording current corresponding to a 0 state and the bit error rate when reading is performed on a digit region in the 0 state. The horizontal axis represents the amplitude of the recording current. The vertical axis represents, by a common logarithm, the bit error rate when reading is performed on a digit region in the 0 state. Hereinafter, a bit error rate when reading is performed on a digit region in the 0 state is simply referred to as a bit error rate.

In the example illustrated in FIG. 3, the bit error rate is minimized with the amplitude of the recording current being around 4 mA. That is, in a case where the amplitude of the recording current is 0 mA, the bit error rate is deteriorated as compared with a case where the amplitude of the recording current is 4 mA.

In the example illustrated in FIG. 3, the amplitude of the recording current for saturation magnetic recording, namely, the amplitude of the recording current corresponding to the −1 state or the +1 state is set to be greater than or equal to 100 mA. In a case where the amplitude of the recording current is greater than 4 mA, the amplitude of the recording current for saturation magnetic recording approaches the amplitude of the recording current as the amplitude of the recording current increases, and thus the bit error rate gradually deteriorates.

Therefore, according to the example illustrated in FIG. 3, the amplitude of the recording current corresponding to the 0 state is set to 4 mA.

However, the value of the amplitude of the recording current corresponding to the 0 state in which the bit error rate can be minimized can depend on the setting of the output of laser light by the laser diode 22ld, the characteristics of the magnetic head 22, the characteristics of a magnetic film of the magnetic disk 11, and others. Therefore, for the amplitude of the recording current corresponding to the 0 state, for example, an optimum value is sought for in the manufacturing process, and a value obtained thereby is determined as the amplitude of the recording current corresponding to the 0 state.

Hereinafter, a set value of the amplitude of the recording current corresponding to the 0 state is referred to as a 0-state amplitude set value.

In order to enable control of the recording current as described above, the RWC 25 and the preamplifier 24 have configurations described below. Hereinafter, the RWC 25 and the preamplifier 24 are referred to as a processing circuit 50.

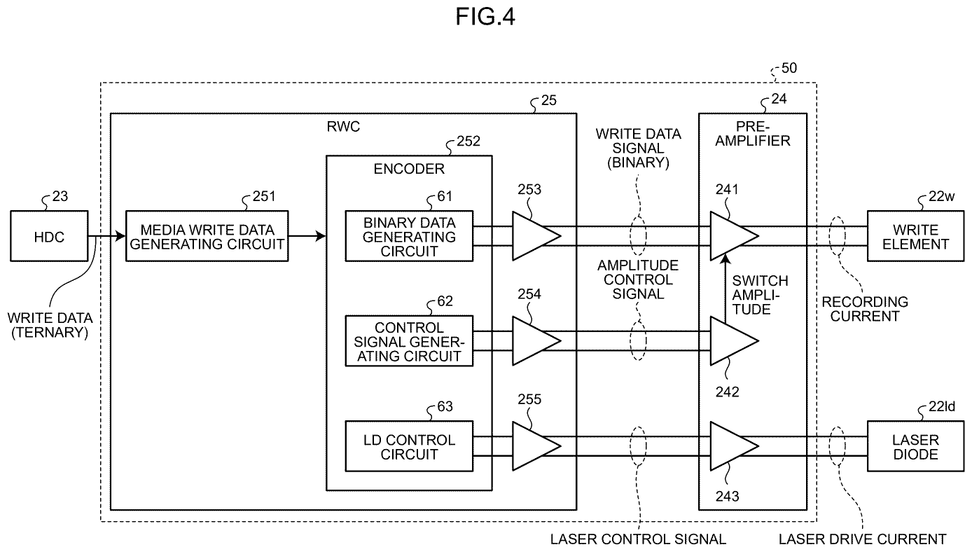

FIG. 4 is a diagram illustrating an example of a detailed configuration of the processing circuit 50 according to the first embodiment.

The RWC 25 includes a media write data generating circuit 251, an encoder 252, a first driver 253, a second driver 254, and a third driver 255. The encoder 252 includes a binary data generating circuit 61, a control signal generating circuit 62, and an LD control circuit 63.

The preamplifier 24 includes a fourth driver 241, a fifth driver 242, and a sixth driver 243.

The media write data generating circuit 251 is supplied with ternary write data from the HDC 23. The ternary write data is a sequence of values that can take “+1”, “−1”, or “0”.

The ternary write data supplied to the media write data generating circuit 251 may have been transmitted from the host 2 to the magnetic disk device 1. Alternatively, the host 2 may transmit binary data to the magnetic disk device 1, and the binary data may be converted into a ternary value by the HDC 23 or another component of the magnetic disk device to generate the ternary write data to be supplied to the media write data generating circuit 251.

The media write data generating circuit 251 performs various types of modulation including error correction coding on the ternary write data. The media write data generating circuit 251 supplies the modulated ternary write data to the encoder 252. Hereinafter, unless otherwise specified, the ternary write data means modulated ternary write data.

The binary data generating circuit 61 generates a write data signal that transitions between the “H” level and the “L” level from the ternary write data. The binary data generating circuit 61 sets the write data signal to the “H” level for the value “+1” in the sequence of the ternary write data. The binary data generating circuit 61 sets the write data signal to the “L” level for the value “−1” in the sequence of the ternary write data.

The binary data generating circuit 61 sets, to a value “0” in the sequence of the ternary write data, a level opposite to a level corresponding to a value immediately after the sequence of one or more consecutive “0” including the value “0”. For example, in a case where a value immediately after the sequence of one or more consecutive “0” is “+1”, the binary data generating circuit 61 sets the write data signal to the “L” level for the sequence of one or more consecutive “0”. In a case where a value immediately after the sequence of one or more consecutive “0” is “−1”, the binary data generating circuit 61 sets the write data signal to the “H” level for the sequence of one or more consecutive “0”.

The control signal generating circuit 62 generates an amplitude control signal in synchronization with the write data signal generated by the binary data generating circuit 61. The amplitude control signal is for the control to set the amplitude of the recording current to the 0-state amplitude set value. The control signal generating circuit 62 causes the amplitude control signal to transition from the “L” level to the “H” level at timing when writing of the sequence of one or more consecutive “0” is started and maintains the amplitude control signal at the “H” level for a period of 1T. The control signal generating circuit 62 maintains the amplitude control signal at the “L” level except for the above period.

Note that “T” is a unit representing a time length or a data length based on the time required for writing single-digit data or the length of single-digit data, respectively. For example, the time required for writing data of N digits (where N is an integer greater than or equal to 0) or the length of data of N digits is expressed as NT.

The LD control circuit 63 outputs a laser control signal that is a signal for controlling the drive current supplied to the laser diode 22ld.

The write data signal generated by the binary data generating circuit 61 is transferred to the preamplifier 24 via the first driver 253. The amplitude control signal generated by the control signal generating circuit 62 is transferred to the preamplifier 24 via the second driver 254. The laser control signal generated by the LD control circuit 63 is transferred to the preamplifier 24 via the third driver 255. Note that each signal is transferred as a differential signal in this example; however, the configuration of each signal is not limited to the differential signal.

In the preamplifier 24, the fourth driver 241 receives the write data signal. The fifth driver 242 receives the amplitude control signal. The sixth driver 243 receives the laser control signal.

The fifth driver 242 transfers the amplitude control signal to the fourth driver 241.

The fourth driver 241 generates a recording current having a waveform corresponding to the write data signal. When generating the recording current, the fourth driver 241 switches the amplitude of the recording current between the value for the saturation magnetic recording and the 0-state amplitude set value on the basis of the amplitude control signal received from the fifth driver 242. More specifically, the fourth driver 241 starts generating a recording current having the amplitude of the 0-state amplitude set value at the timing when the amplitude control signal transitions from the “L” level to the “H” level. At the timing of the transition from the “H” level to the “L” level, the fourth driver 241 starts generating a recording current for the saturation magnetic recording. The recording current generated by the fourth driver 241 is supplied to the write element 22w.

The sixth driver 243 generates a current (hereafter referred to as the laser drive current) for driving the laser diode 22ld on the basis of the laser control signal. The laser drive current is supplied to the laser diode 22ld, and the laser diode 22ld emits laser light on the basis of the laser drive current.

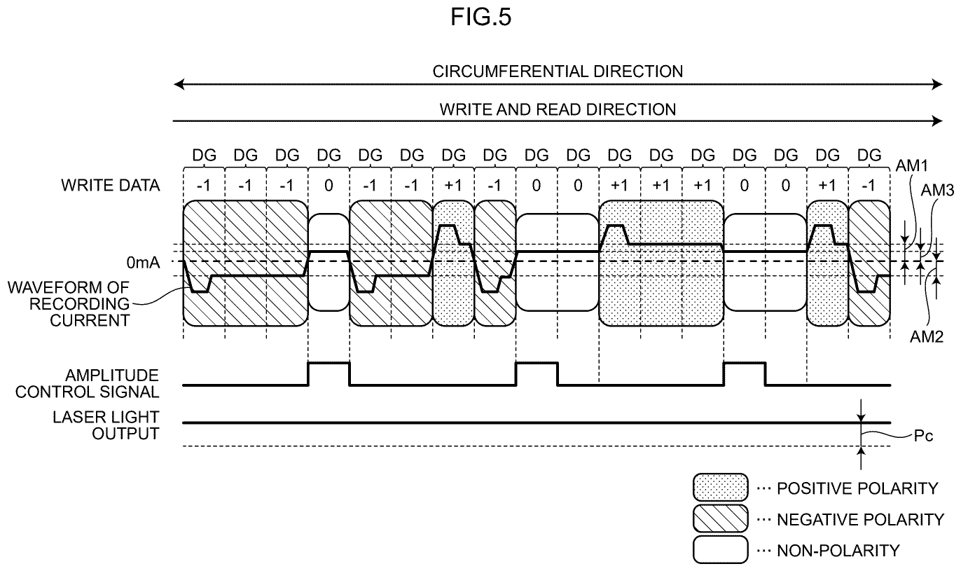

FIG. 5 is a diagram for describing a specific example of a recording method according to the first embodiment.

FIG. 5 illustrates a sequence of values included in write data and the magnetization state of a target track 41 after being magnetized by writing of the write data. In this drawing, the magnetization state is indicated by dot hatching, oblique hatching, and a hollow square. The dot hatching indicates positive polarity, the oblique hatching indicates negative polarity, and a hollow square indicates non-polarity.

Furthermore, a boundary in the circumferential direction of each of a plurality of digit regions DG arranged along the track 41 is indicated by a dotted line.

In addition, the waveform of the amplitude control signal, the waveform of the output of laser light by the laser diode 22ld, and the waveform of the recording current are illustrated. Each waveform is illustrated such that the time axis of the waveform corresponds to the circumferential position in the track 41.

In the example illustrated in FIG. 5, a sequence of “−1, −1, −1, 0, −1, −1, +1, −1, 0, 0, +1, +1, +1, 0, 0, +1, −1” is illustrated as an example of the ternary write data. Note that, in the present specification, a sequence of values is described in chronological order.

The output of laser light is controlled to be constant at a value Pc at which the temperature at the irradiation position can be made higher than or equal to the Curie temperature during writing of write data.

The amplitude of the recording current corresponding to the +1 state is set to a value AW1. The amplitude of the recording current corresponding to the −1 state is set to a value AW2. The saturation magnetic recording is implemented by a recording current having amplitudes of these values.

At the timing of writing “+1” or “−1” after writing another value when a plurality of values included in write data is sequentially written, the amplitude of the recording current is temporarily increased to be greater than the value AW1 or AW2 in order to quickly stabilize the magnetic field of the write element 22w. In such a waveform of the recording current, a portion, where the amplitude of the recording current is temporarily increased immediately after the data value changes, is known as an overshoot amplitude (OSA). During the period after the OSA to the next data change, the amplitude of the recording current is maintained at a constant value in order to maintain the magnetic field of the write element 22w. The portion where the amplitude of the recording current is maintained at the constant value is referred to as IW.

The amplitude of the recording current corresponding to the 0 state is set to a value AW3. The value AW3 is a value set as the 0-state amplitude set value. Therefore, the value AW3 is smaller than both the value AW1 and the value AW2 and is a non-zero value.

The amplitude control signal is caused to transition from the “L” level to the “H” level at the timing when writing of the sequence of one or more consecutive “0” is started. The amplitude control signal is maintained at the “H” level for a period during which writing of a sequence of “0” is started and then is caused to transition to the “L” level.

As the amplitude control signal transitions from the “L” level to the “H” level, the supply of a positive recording current having the amplitude of the value AW3 to the write element 22w is started. After the supply of the positive recording current with the amplitude of the value AW3 to the write element 22w is started, the supply of the positive recording current with the amplitude of the value AW3 to the write element 22w is ended at the timing when the writing of the sequence of one or more consecutive “0” is ended, and writing by the recording current with the amplitudes of the values AW1 and AW2 is resumed.

Note that, in the example illustrated in FIG. 5, writing of “0” is performed by the positive recording current having the amplitude of the value AW3. The sign of the recording current is not limited to the positive sign. The RWC 25 and the preamplifier 24 may be configured such that writing of “0” is performed by a negative recording current having the amplitude of the value AW3. However, the sign of the recording current for the writing of “0” is fixed to either the positive or negative sign.

As described above, according to the first embodiment, the processing circuit 50 is capable of writing any of “+1”, “−1”, or “0” in a digit region DG. The operation of writing “+1” in a digit region DG is, specifically, magnetizing the digit region DG to positive polarity with the processing circuit 50 supplying a positive recording current with the amplitude of the value AW1 to the write element 22w while causing the laser diode 22ld to output laser light. The operation of writing “−1” in a digit region DG is, specifically, magnetizing the digit region DG to negative polarity with the processing circuit 50 supplying a negative recording current with the amplitude of the value AW2 to the write element 22w while causing the laser diode 22ld to output laser light. The operation of writing “0” in a digit region DG is, specifically, making the magnetization state of the digit region DG to non-polarity with the processing circuit 50 supplying a recording current of the preset positive or negative sign with the amplitude of the value AW3 to the write element 22w while causing the laser diode 22ld to output laser light. The value AW3 is smaller than both the value AW1 and the value AW2 and is a non-zero value.

With the recording current having a present sign of either positive or negative sign and the non-zero amplitude supplied to the write element 22w when “0” is written to the digit region DG, the fluctuation in the amplitude of the reproduction signal is suppressed when reading is performed on the digit region DG in the 0 state. As a result, the bit error rate at the time of reading from the digit region DG in the 0 state is suppressed. That is, a signal that can take three levels can be suitably written to the magnetic disk 11.

Note that, in the above description, the example has been described in which a signal that can take three levels is written to the magnetic disk 11. The technology of the first embodiment is also applicable to a magnetic disk device in which a signal that can take four or more levels is written to a magnetic disk. Writing of a signal of one specific level corresponding to the nonpolar state among the four or more levels that the signal can take is implemented by the processing circuit supplying the recording current of the preset positive and negative signs of the amplitude of the value AW3 to the write element while causing the laser diode 22ld to output laser light. As a result, the bit error rate when a signal at the specific level is read is suppressed. That is, a signal that can take three or more levels can be suitably written to the magnetic disk.

### First Modification

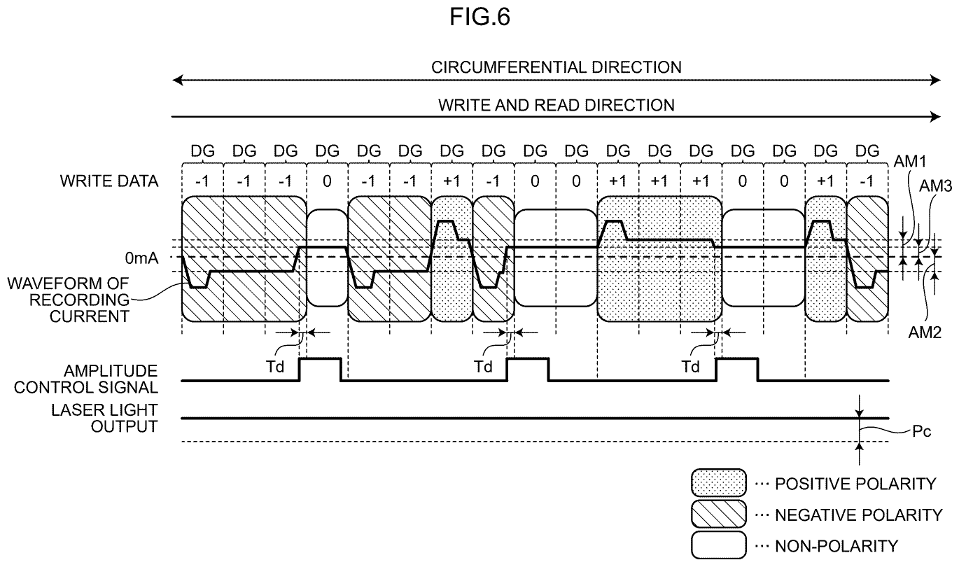

A first modification will be described as a modification of the first embodiment. According to the first modification, for example, as illustrated in FIG. 6, the amplitude control signal is caused to transition from the “L” level to the “H” level at timing earlier by time Td than the timing at which writing of the sequence of one or more consecutive “0” is started.

The write element has a region to be recorded on the magnetic disk at a time due to the effect of the size of a magnetic pole. This region is referred to as a footprint. When the amplitude of the recording current is switched such that the timing at which the amplitude of the recording current is switched to the 0-state amplitude set value is equal to the timing at which the write element reaches the digit region DG, due to the effect of the footprint, there is a possibility that saturation magnetic recording is performed on a part of the digit region DG beyond the boundary of the digit region DG, which is the write destination of “0”.

According to the first modification, the transition timing of the amplitude control signal can be continuously adjusted. Moreover, the amplitude of the recording current is switched to the 0-state amplitude set value at timing earlier by the time Td, which corresponds to the length of the footprint, than the timing at which the write element 22w reaches the digit region DG as the write destination of “0”. As a result, it is possible to prevent the saturation magnetic recording from being performed on a part of the digit region DG beyond the boundary of the digit region DG as the write destination of “0”. As a result, the recording quality in the 0 state is improved.

### Second Modification

A second modification will be described as another modification of the first embodiment. The technology of the second modification can be used in combination with the technology of the first modification.

According to the second modification, in the RWC 25, the control signal generating circuit 62 instructs the preamplifier 24 to set the amplitude of the recording current to the 0-state amplitude set value by the amplitude control signal during the period of writing a sequence of one or more consecutive “0”. In the preamplifier 24, the fourth driver 241 switches the amplitude of the recording current between either the value AW1 or AW2 and the value AW3 under the control by the fifth driver 242. The fourth driver 241 sets the amplitude of the recording current to the value AW3 while the amplitude control signal is at the “H” level and sets the amplitude of the recording current to the values AW1 and AW2 while the amplitude control signal is at the “L” level.

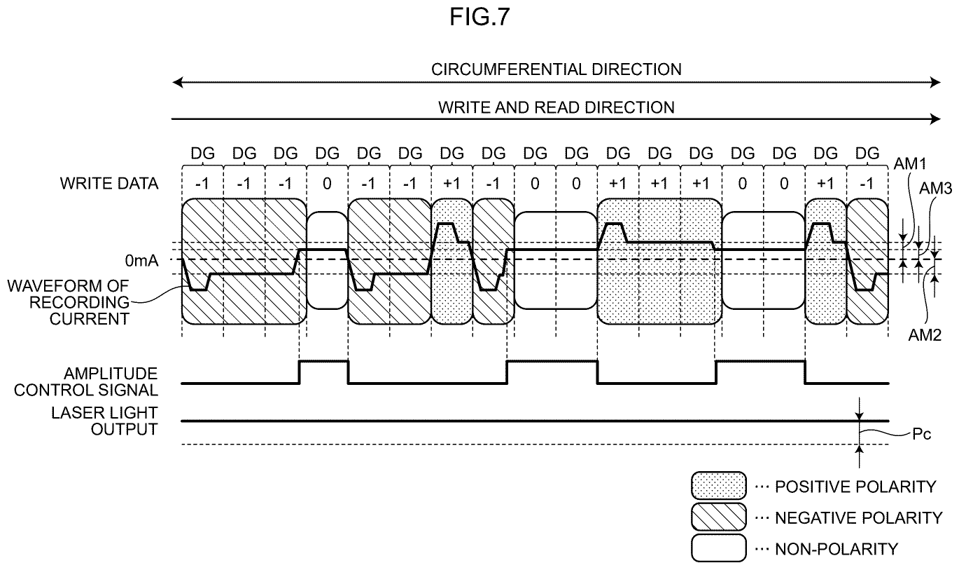

Therefore, for example, as illustrated in FIG. 7, the amplitude control signal is maintained at the “H” level during a period of writing sequence of one or more consecutive “0”. As a result, during this period, the amplitude of the recording current is set to the value AW3, and the digit region DG as the recording destination of “0” is set to the 0 state.

### Third Modification

A third modification will be described as still another modification of the first embodiment. The technology of the third modification can be used in combination with both the technology of the first modification and the technology of the second modification.

As methods for controlling the amplitude of the recording current, a pulse based writing (PBW) method and a main pole relaxation zone (MPRZ) method are known. In the third modification, technology for implementing three states of the +1 state, the 0 state, and the −1 state in a case where these methods are applied will be described.

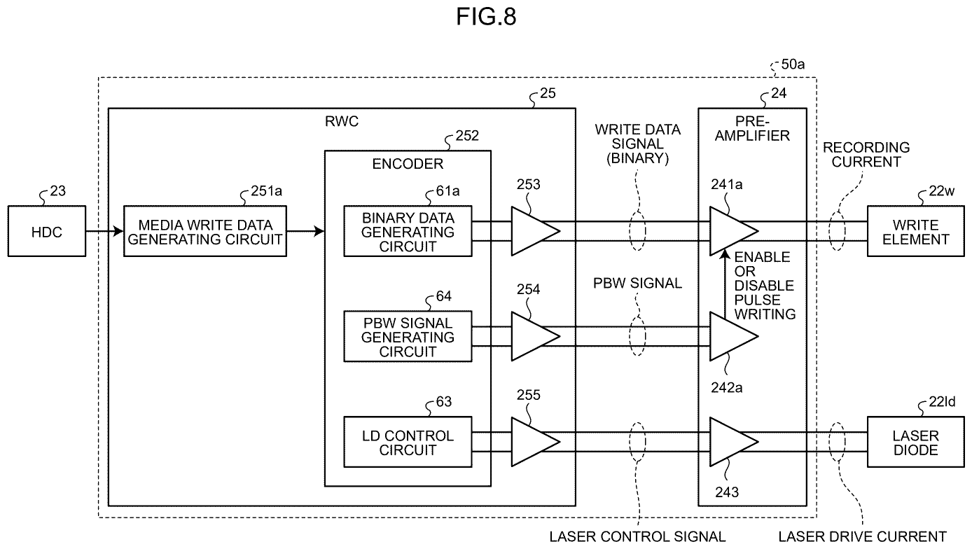

FIG. 8 is a diagram illustrating an example of a detailed configuration of a processing circuit 50a to which the PBW method is applied according to the third modification. Note that, among the components of the processing circuit 50a, the same components as those of the first embodiment will not be described or will be briefly described.

An RWC 25 includes a media write data generating circuit 251a, an encoder 252, a first driver 253, a second driver 254, and a third driver 255. The encoder 252 includes a binary data generating circuit 61a, a PBW signal generating circuit 64, and an LD control circuit 63.

A preamplifier 24 includes a fourth driver 241a, a fifth driver 242a, and a sixth driver 243.

With respect to ternary write data output from the media write data generating circuit 251a, the value of a sequence of one or more consecutive “0” and the value immediately after the sequence are set to be the same. For example, in a case where the value immediately before the sequence of one or more consecutive “0” is “−1”, the value immediately after the sequence of one or more consecutive “0” is set to be “−1”. In a case where the value immediately before the sequence of one or more consecutive “0” is “+1”, the value immediately after the sequence of one or more consecutive “0” is set to be “+1”. The media write data generating circuit 251a may generate ternary write data satisfying the above constraint by modulation. Alternatively, ternary write data satisfying the above constraint may be generated by the HDC 23 or the host 2.

The binary data generating circuit 61a generates a write data signal that transitions between the “H” level and the “L” level from the ternary write data. The binary data generating circuit 61a sets the write data signal to the “H” level for the value “+1” in the sequence of the ternary write data. The binary data generating circuit 61a sets the write data signal to the “L” level for the value “−1” in the sequence of the ternary write data.

The binary data generating circuit 61a sets, for a sequence of one or more consecutive “0” in the sequence of the ternary write data, the write data signal to a level opposite to a level corresponding to the value immediately before the sequence of one or more consecutive “0”. For example, in a case where the sequence of the ternary write data is “−1, 0, −1”, the binary data generating circuit 61 a generates the write data signal that transitions in the order of “L, H, L”. In a case where the sequence of the ternary write data is “+1, 0, +1”, the binary data generating circuit 61a generates the write data signal that transitions in the order of “H, L, H”. The write data signal generated by the binary data generating circuit 61a is transferred to the preamplifier 24 via the first driver 253.

The PBW signal generating circuit 64 generates a PBW signal. The PBW signal is a signal for controlling pulse writing. The pulse writing is a writing method in which a recording current of a waveform of a pulse having an amplitude of a predetermined value is caused to flow through the write element 22w. In the third modification, the pulse writing is used as writing with the recording current of the amplitude of the 0-state amplitude set value.

The pulse writing is started when the PBW signal is at the “H” level at the timing of the edge of the write data signal. Then, the pulse writing is terminated at the next edge of the write data signal. Therefore, the PBW signal generating circuit 64 causes the PBW signal to transition from the “L” level to the “H” level at timing slightly earlier than the timing at which writing of the sequence of one or more consecutive “0” is started and maintains the PBW signal at the “H” level for a period of 1T. The PBW signal generating circuit 64 maintains the PBW signal at the “L” level except for the above period. The PBW signal generated by the PBW signal generating circuit 64 is transferred to the preamplifier 24 via the second driver 254.

In the preamplifier 24, the fourth driver 241a receives the write data signal. The fifth driver 242a receives the PBW signal.

The fifth driver 242a transfers the received PBW signal to the fourth driver 241a. The fourth driver 241a controls enabling and disabling of the pulse writing on the basis of the PBW signal received from the fifth driver 242a. In a case where the PBW signal is at the “H” level at the timing of the edge of the write data signal, the fourth driver 241a starts generating the recording current having the amplitude of the 0-state amplitude set value. Then, the fourth driver 241a terminates the generation of the recording current having the amplitude of the 0-state amplitude set value at the timing of the edge of the write data signal and generates the recording current for saturation magnetic recording.

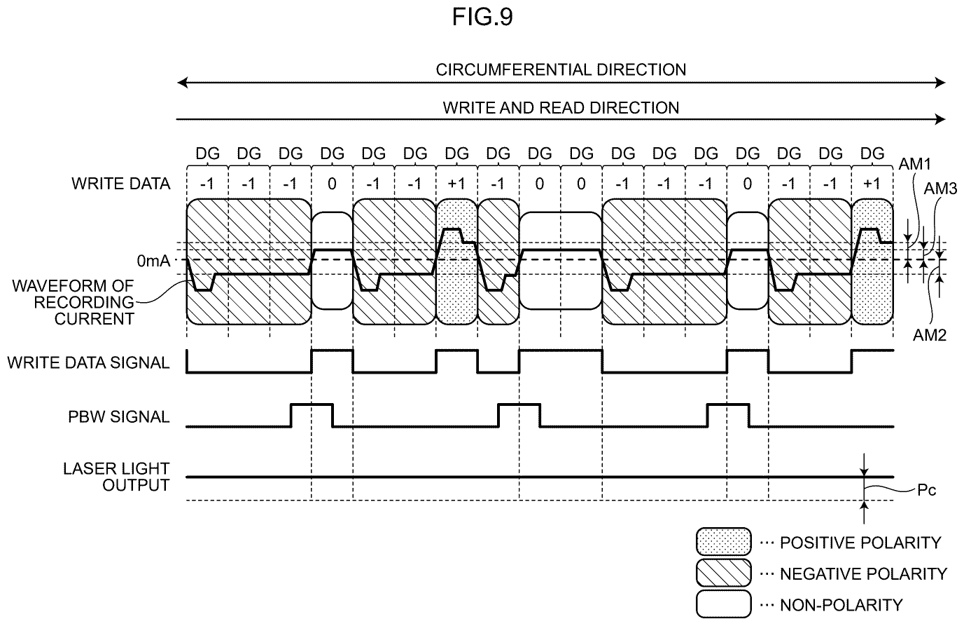

FIG. 9 is a diagram for describing a specific example of a recording method to which the PBW method is applied according to the third modification.

FIG. 9 illustrates a sequence of write data and the magnetization state of a target track 41 after writing of the sequence of the write data. In addition, the waveform of a write data signal, the waveform of a PBW signal, the waveform of output of laser light, and the waveform of the recording current are illustrated.

As illustrated in FIG. 9, in a period in which a sequence of one or more consecutive “0” is written, the write data signal is set to a level opposite to a level corresponding to the value immediately before the sequence of one or more consecutive “0”. For example, in a case where the write data sequence is “−1, 0, −1”, the write data signal transitions as “L, H, L”. Meanwhile, in a case where the write data sequence is “−1, 0, 0, −1”, the write data signal transitions as “L, H, H, L”. In addition, the PBW signal is maintained at the “H” level for the period of 1T at timing slightly earlier than the timing at which writing of the sequence of one or more consecutive “0” is started.

Moreover, when the PBW signal is at the “H” level at the timing of the edge of the write data signal, the amplitude of the recording current changes from AW1 or AW2 (AW2 in the example of FIG. 9), which are amplitudes for saturation magnetic recording, to AW3. Then, the amplitude of the recording current is returned from AW3 to AW1 or AW2 (AW2 in the example of FIG. 9) at the timing of a next edge of the write data signal. In this manner, data of “0” of 1T and data of “0” of 2T are written.

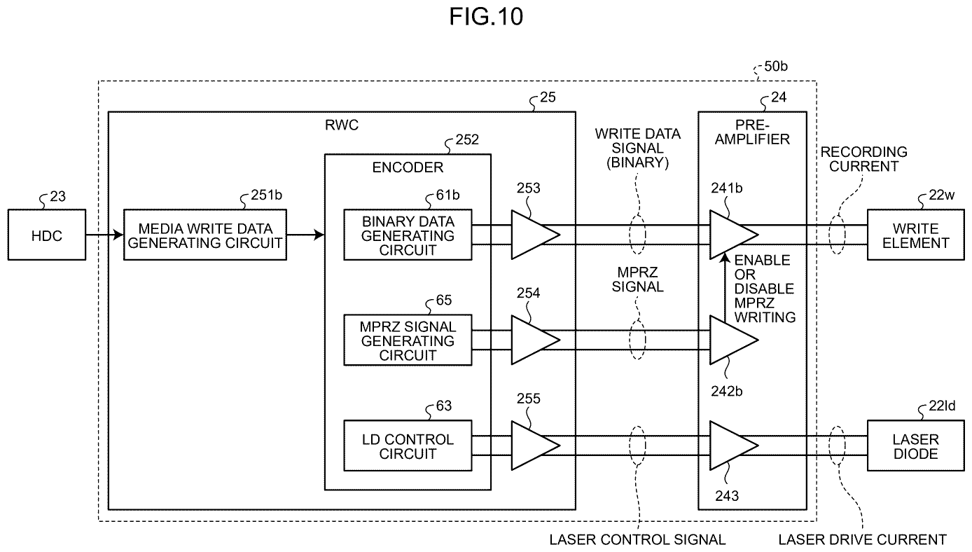

FIG. 10 is a diagram illustrating an example of a detailed configuration of a processing circuit 50b to which the MPRZ method is applied according to the third modification.

An RWC 25 includes a media write data generating circuit 251b, an encoder 252, a first driver 253, a second driver 254, and a third driver 255. The encoder 252 includes a binary data generating circuit 61b, an MPRZ signal generating circuit 65, and an LD control circuit 63.

A preamplifier 24 includes a fourth driver 241b, a fifth driver 242b, and a sixth driver 243.

The media write data generating circuit 251b generates binary data from ternary write data and generates a write data signal corresponding to the binary data. However, in the ternary write data, a value immediately before and a value immediately after a sequence of one or more consecutive “0” are different from each other. For example, in a case where the value immediately before the sequence of one or more consecutive “0” is “−1”, the value immediately after the sequence of one or more consecutive “0” is set to be “+1”. In a case where the value immediately before the sequence of one or more consecutive “0” is “−1”, the value immediately after the sequence of one or more consecutive “0” is set to be “+1”.

The binary data generating circuit 61b generates a write data signal that transitions between the “H” level and the “L” level from the ternary write data. The binary data generating circuit 61b sets the write data signal to the “H” level for the value “+1” in the sequence of the ternary write data. The binary data generating circuit 61b sets the write data signal to the “L” level for the value “−1” in the sequence of the ternary write data.

The binary data generating circuit 61b sets, for a sequence of one or more consecutive “0” in the sequence of the ternary write data, the write data signal to a level same as the level corresponding to the value immediately before the sequence of one or more consecutive “0”. For example, in a case where the sequence of the ternary write data is “−1, 0, +1”, the binary data generating circuit 61b generates the write data signal that transitions in the order of “L, L, H”. In a case where the sequence of the ternary write data is “+1, 0, −1”, the binary data generating circuit 61b generates the write data signal that transitions in the order of “H, H, L”. The write data signal generated by the binary data generating circuit 61b is transferred to the preamplifier 24 via the first driver 253.

The MPRZ signal generating circuit 65 generates an MPRZ signal. The MPRZ signal is a signal for controlling MPRZ writing. The MPRZ writing is to change the amplitude to a predetermined value in the middle of writing. In the third modification, in the MPRZ writing, the amplitude of the recording current is set to the 0-state amplitude set value.

The MPRZ signal generating circuit 65 maintains the MPRZ signal at the “H” level for the period of 1T from the timing of starting writing of a sequence of one or more consecutive “0”. The MPRZ signal generating circuit 65 maintains the MPRZ signal at the “L” level except for the above period. The MPRZ signal generated by the MPRZ signal generating circuit 65 is transferred to the preamplifier 24 via the second driver 254.

In the preamplifier 24, the fourth driver 241b receives the write data signal. The fifth driver 242b receives the MPRZ signal.

The fifth driver 242b transfers the received MPRZ signal to the fourth driver 241b. The fourth driver 241b controls enabling and disabling MPRZ writing on the basis of the MPRZ signal received from the fifth driver 242b. The fourth driver 241b starts generating the recording current having the amplitude of the 0-state amplitude set value at the timing when the MPRZ signal transitions from the “L” level to the “H” level. Then, the fourth driver 241b terminates the generation of the recording current having the amplitude of the 0-state amplitude set value at the timing of the edge of the write data signal and generates the recording current for saturation magnetic recording.

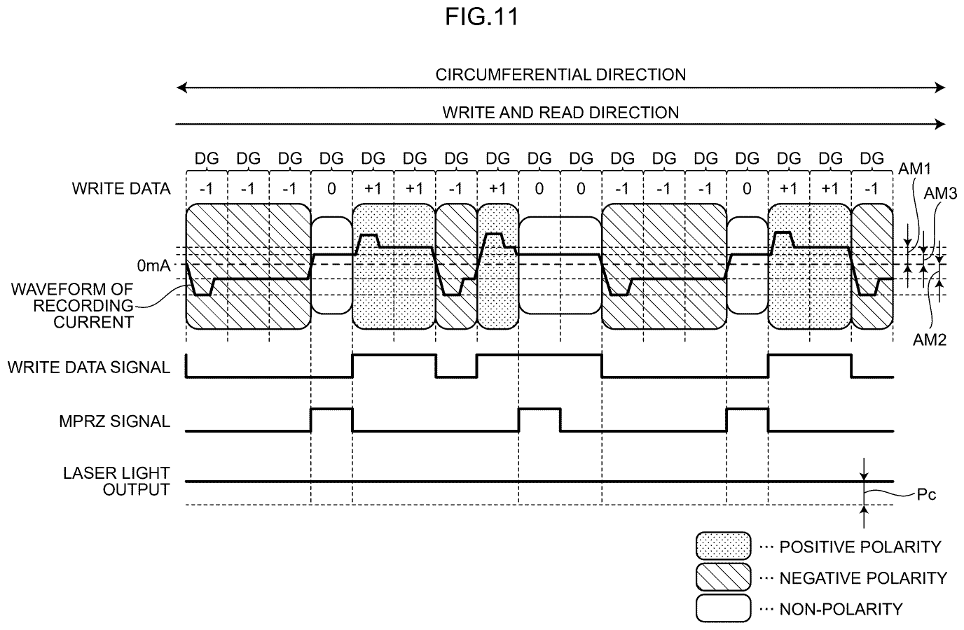

FIG. 11 is a diagram for describing a specific example of a recording method to which an NPRZ method is applied according to the third modification.

FIG. 11 illustrates a sequence of write data and the magnetization state of a target track 41 after writing of the sequence of the write data. In addition, the waveform of a write data signal, the waveform of an NPRZ signal, the waveform of output of laser light, and the waveform of the recording current are illustrated.

As illustrated in FIG. 11, in a period in which a sequence of one or more consecutive “0” is written, the write data signal is set to a level same as the level corresponding to the value immediately before the sequence of one or more consecutive “0”. In addition, the MPRZ signal is maintained at the “H” level for the period of 1T from the timing at which writing of the sequence of one or more consecutive “0” is started.

At the timing when the MPRZ signal transitions from the “L” level to the “H” level regardless of the level of the write data signal, the amplitude of the recording current changes from AW1 or AW2, which are amplitudes for saturation magnetic recording, to AW3. Then, the amplitude of the recording current is returned from AW3 to AW1 or AW2 at the timing of a next edge of the write data signal. In this manner, data of “0” of 1T and data of “0” of 2T are written.

### Fourth Modification

In the third modification, either one of the PBR method or the MPRZ method is applied. Therefore, with respect to the ternary write data, there is a constraint on the relationship between the value immediately before the sequence of one or more consecutive “0” and the value immediately after the sequence of one or more consecutive “0”. By applying both the PBR method and the MPRZ method, such a constraint can be eliminated. As a fourth modification, a magnetic disk device 1 to which the PBR method and the MPRZ method are applied will be described. The fourth modification can be used in combination with the first modification.

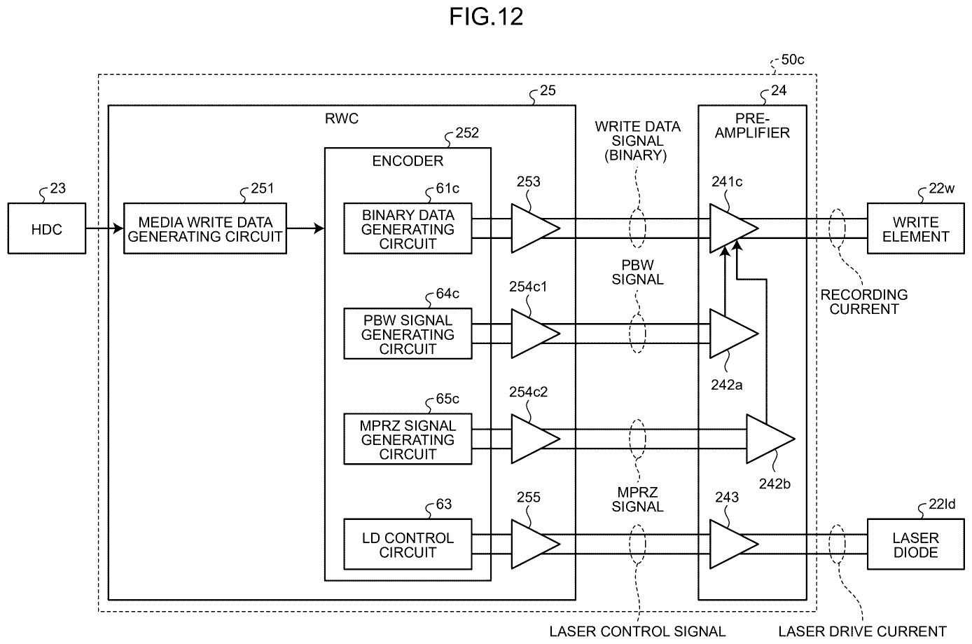

FIG. 12 is a diagram illustrating an example of a detailed configuration of a processing circuit 50c to which the MPRZ method is applied according to the fourth modification.

An RWC 25 includes a media write data generating circuit 251, an encoder 252, a first driver 253, a second driver 254c1, a second driver 254c2, and a third driver 255. The encoder 252 includes a binary data generating circuit 61c, a PBW signal generating circuit 64c, an MPRZ signal generating circuit 65c, and an LD control circuit 63.

A preamplifier 24 includes a fourth driver 241c, a fifth driver 242a, a fifth driver 242b, and a sixth driver 243.

The binary data generating circuit 61c generates a write data signal that transitions between the “H” level and the “L” level from ternary write data. The binary data generating circuit 61c sets the write data signal to the “H” level for the value “+1” in a sequence of the ternary write data. The binary data generating circuit 61c sets the write data signal to the “L” level for the value “−1” in the sequence of the ternary write data.

The binary data generating circuit 61c determines, for a sequence of one or more consecutive “0” in the sequence of the ternary write data, the level of the write data signal depending on the value immediately before the sequence of one or more consecutive “0” and the value immediately after the sequence of one or more consecutive “0”.

In a case where the value immediately before the sequence of one or more consecutive “0” and the value immediately after the sequence of one or more consecutive “0” are the same, the binary data generating circuit 61c sets the write data signal to a level opposite to a level corresponding to the value immediately before the sequence of one or more consecutive “0”. That is, the binary data generating circuit 61c performs similar operation to that of the binary data generating circuit 61a of the third modification.

In a case where the value immediately before the sequence of one or more consecutive “0” and the value immediately after the sequence of one or more consecutive “0” are different from each other, the binary data generating circuit 61c sets the write data signal to a level same as the level corresponding to the value immediately before the sequence of one or more consecutive “0”. That is, the binary data generating circuit 61c performs similar operation to that of the binary data generating circuit 61b of the third modification.

The PBW signal generating circuit 64c generates a PBW signal. In a case where the value immediately before the sequence of one or more consecutive “0” and the value immediately after the sequence of one or more consecutive “0” are the same, the PBW signal generating circuit 64c causes the PBW signal to transition from the “L” level to the “H” level at timing slightly earlier than the timing at which writing of the sequence of one or more consecutive “0” is started and maintains the PBW signal at the “H” level for the period of 1T. Other than the above period, the PBW signal generating circuit 64c maintains the PBW signal at the “L” level. The PBW signal generated by the PBW signal generating circuit 64c is transferred to the preamplifier 24 via the second driver 254c1.

The MPRZ signal generating circuit 65c generates an MPRZ signal. In a case where the value immediately before the sequence of one or more consecutive “0” and the value immediately after the sequence of one or more consecutive “0” are different from each other, the MPRZ signal generating circuit 65c maintains the MPRZ signal at the “H” level during the period of 1T from the timing at which writing of the sequence of one or more consecutive “0” is started. The MPRZ signal generating circuit 65c maintains the MPRZ signal at the “L” level except for the above period. The MPRZ signal generated by the MPRZ signal generating circuit 65c is transferred to the preamplifier 24 via the second driver 254c2.

In the preamplifier 24, the fourth driver 241c receives the write data signal. The fifth driver 242a receives the PBW signal. The fifth driver 242b receives the MPRZ signal.

The fifth driver 242a performs the same operation as that of the fifth driver 242a according to the third modification. The fifth driver 242b performs the same operation as that of the fifth driver 242b according to the third modification. The fourth driver 241c executes the same operation as that of the fourth driver 241a of the third modification and the same operation as that of the fourth driver 241b of the third modification.

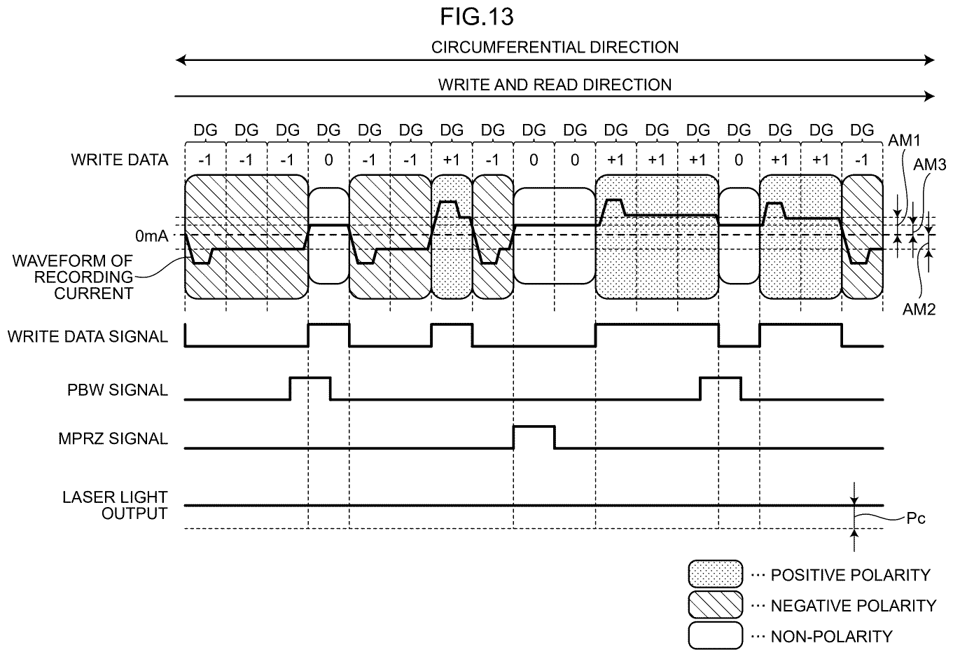

FIG. 13 is a diagram for describing a specific example of a recording method according to the fourth modification.

FIG. 13 illustrates a sequence of write data and the magnetization state of a target track 41 after writing of the sequence of the write data. In addition, the waveform of a write data signal, the waveform of a PBW signal, the waveform of output of an MPRZ signal, the waveform of output of laser light, and the waveform of the recording current are illustrated.

As illustrated in FIG. 13, in a case where a value immediately before a sequence of one or more consecutive “0” and a value immediately after the sequence of one or more consecutive “0” are the same, writing of “0” is implemented by the PBW method. In a case where a value immediately before a sequence of one or more consecutive “0” and a value immediately after the sequence of one or more consecutive “0” are different from each other, writing of “0” is implemented by the MPRZ method. Therefore, regarding the ternary write data, “0” can be written regardless of the relationship between the value immediately before “0” and the value immediately before “0”.

### Fifth Modification

As another recording method other than the PBW method or the MPRZ method, an advanced PBW method is known. In the advanced PBW method, a recording current having a pulsed waveform is individually used for each digit region DG. As the recording method, the advanced PBW method can also be applied.

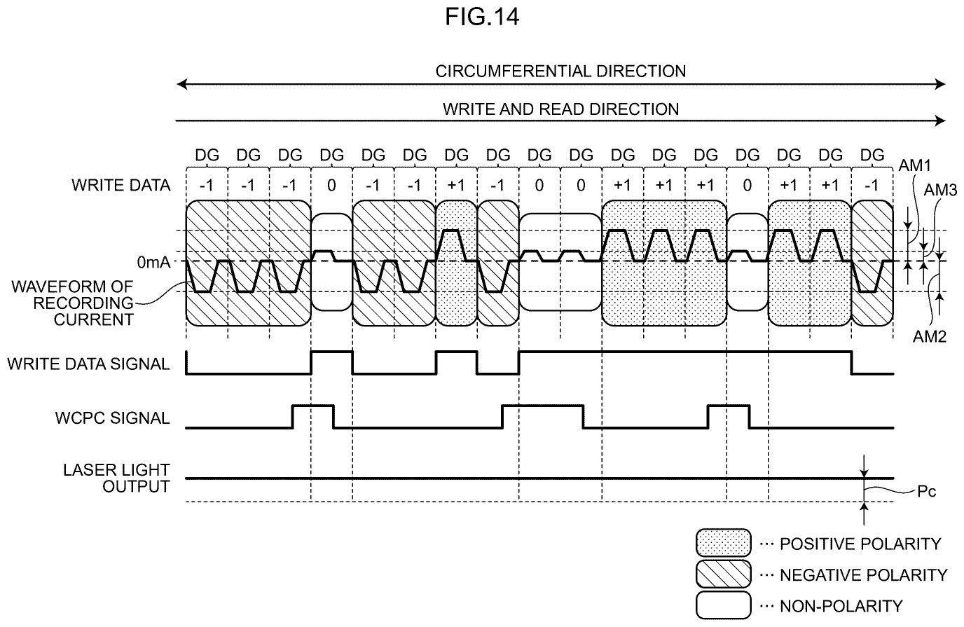

FIG. 14 is a diagram for describing a specific example of a recording method according to a fifth modification. In the fifth modification, the advanced PBW method is applied. Therefore, as illustrated in FIG. 14, writing is individually performed by a recording current having a pulsed waveform for each digit region DG. A WCPC signal is a signal transferred from the RWC 25 to the preamplifier 24 and is a signal for changing the amplitude with respect to a recording current having a specific pulsed-shape.

As illustrated in FIG. 14, in a case where the advanced PBW method is applied, regarding the ternary write data, it is possible to write “0” regardless of the relationship between a value immediately before “0” and a value immediately before “0”.

### Second Embodiment

In the first embodiment and the modifications, the output of laser light is controlled to be constant regardless of the value written in a digit region DG. The output of laser light may be dynamically controlled. Note that the technology of the second embodiment can be used in combination with the technology of the first embodiment and the modifications.

The relationship between the fluctuation in the amplitude of a reproduction signal when reading is performed on a large number of 0-state digit regions DG and the output of laser light may change depending on the length of the sequence of one or more consecutive “0”. The length of the sequence of one or more consecutive “0” is referred to as a data length of “0”. Note that the data length of “0” can also be considered as the number of digit regions DG consecutive in the circumferential direction in which “0” is written.

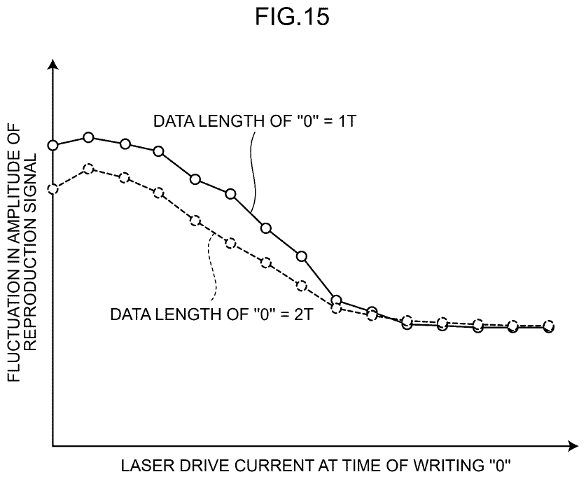

FIG. 15 is a graph showing, for each of the case where the data length of “0” to be written is 1T and the case where the data length of “0” to be written is 2T, the relationship between the laser drive current at the time of writing “0” and the fluctuation in the amplitude of a reproduction signal when reading is performed on a large number of digit regions DG where “0” is written. The horizontal axis represents the laser drive current at the time of writing “0”. The vertical axis represents the fluctuation in the amplitude of the reproduction signal when reading is performed on a large number of digit regions DG in which “0” is written. The laser drive current corresponds to the output of laser light of the laser diode 22ld.

Hereinafter, the fluctuation in the amplitude of the reproduction signal means the fluctuation in the amplitude of the reproduction signal when reading is performed on a large number of digit regions DG in which “0” is written.

If the output of laser light is excessive, a track 41 adjacent to a target track 41 is affected, or the lifetime of the laser diode 22ld is shortened. Conversely, if the output of laser light is insufficient, the fluctuation in the amplitude of the reproduction signal increases, whereby the bit error rate increases. Therefore, it is desirable to suppress the output of laser light as much as possible while suppressing the fluctuation in the amplitude of the reproduction signal as appropriate.

It can be seen from FIG. 15 that, in a case where the output of laser light is reduced, the fluctuation in the amplitude of the reproduction signal is larger in the case where the data length of “0” to be written is 1T than in the case where the data length of “0” to be written is 2T although the output of laser light is the same.

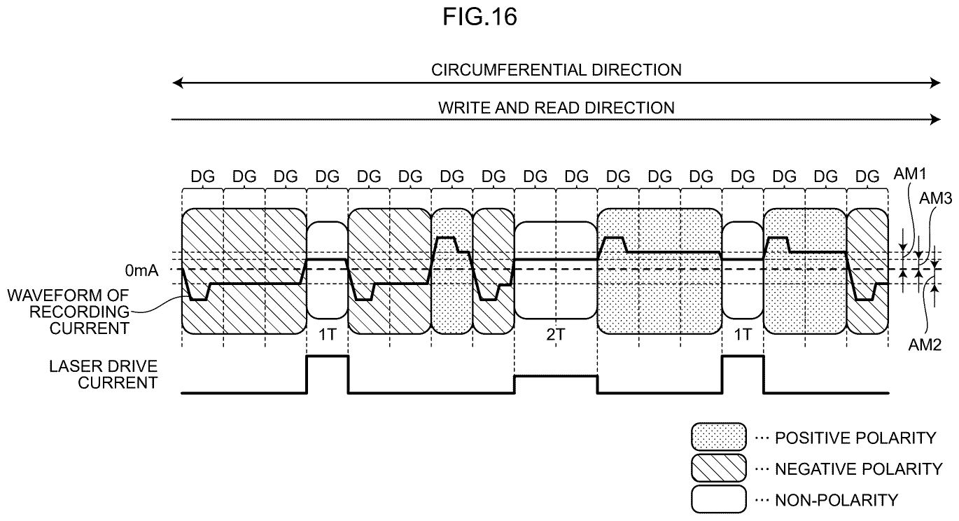

Therefore, in the second embodiment, for example, as illustrated in FIG. 16, in the case where the data length of “0” to be written is 1T, the processing circuit 50d performs control to increase the output of laser light as compared to the case where the data length of “0” to be written is 2T. As a result, deterioration of the fluctuation in the amplitude of the reproduction signal due to the data length of “0” to be written at the time of writing “0” having the data length of 1T is suppressed.

The intensity of the laser output in a case where the data length of “0” to be written is longer than or equal to 3T may be the same as that in the case where the data length of “0” to be written is 2T or may be shorter than that in the case where the data length of “0” to be written is 2T. The longer the data length of “0” to be written, the weaker the laser output may be.

As described above, according to the second embodiment, the processing circuit 50d changes the output of laser light at the time of writing “0” depending on the data length of “0” to be written, namely, the number of consecutive digit regions DG to which “0” is written. More specifically, considering from the viewpoint of the number of consecutive digit regions DG to which “0” is written, in a case where the number of consecutive digit regions DG to which “0” is written is a first number, the processing circuit 50d increases the output of laser light as compared with a case where the number of consecutive digit regions DG to which “0” is written is a second number greater than the first number.

Therefore, the deterioration of the fluctuation in the amplitude of the reproduction signal due to the data length of “0” to be written is suppressed. As a result, deterioration of the bit error rate due to the data length of “0” to be written is suppressed.

### Third Embodiment

In a case where data of “0” is written to a digit region DG in which old data is written, the relationship between the fluctuation in the amplitude of a reproduction signal and the output of laser light may change depending on the length of the old data. The length of the old data herein refers to the length of a sequence of the same value written in one or more digit regions DG that are consecutive in the circumferential direction. That is, the term is synonymous with the number of consecutive digit regions DG in the same state of the +1 state, the −1 state, or the 0 state.

Hereinafter, old data written in a digit region DG before data “0” is written to the digit region DG is referred to as pre-written data. In addition, the number of consecutive digit regions DG that are in the same state as the state of a digit region DG as a write destination of “0”, of the +1 state, the −1 state, or the 0 state, the consecutive digit regions DG including the digit region DG as the write destination of “0”, is referred to as the length of pre-written data.

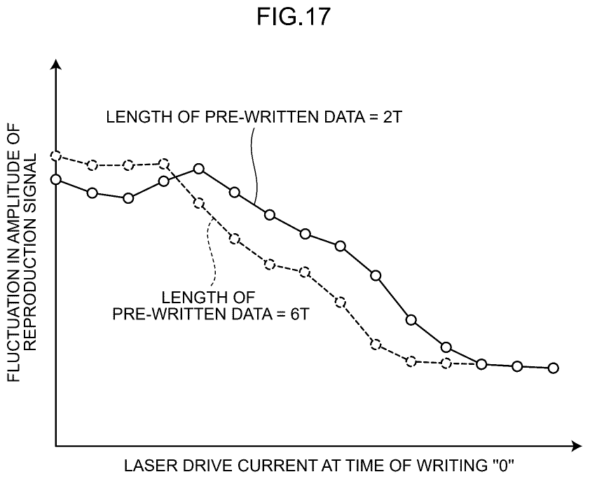

FIG. 17 is a graph showing, for each of a case where the length of pre-written data is 2T and a case where the length of pre-written data is 6T, the relationship between the laser drive current at the time of writing “0” and the fluctuation in the amplitude of the reproduction signal when reading is performed on a large number of digit regions DG in which “0” is written.

It can be seen from FIG. 17 that, in a case where the output of laser light is reduced, the fluctuation in the amplitude of the reproduction signal is larger in the case where the length of pre-written data is short than in the case where the length of pre-written data is long although the output of laser light is the same.

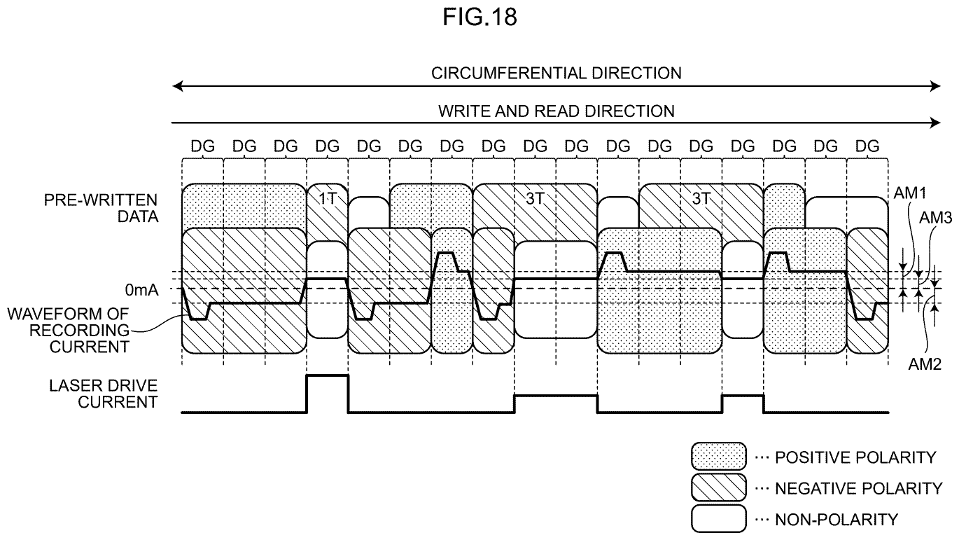

Therefore, in the third embodiment, for example, as illustrated in FIG. 18, in the case where the length of pre-written data is short, the processing circuit 50e performs control to increase the output of laser light as compared to the case where the length of pre-written data is long. As a result, deterioration of the fluctuation in the amplitude of the reproduction signal due to the length of the pre-written data is suppressed.

Note that FIG. 18 illustrates pre-written data as the magnetization state of a digit region DG. To facilitate understanding of the pre-written data, the magnetization state of the digit regions DG corresponding to the pre-written data is illustrated by being shifted from the track center.

FIG. 18 illustrates waveforms of the laser drive current (in other words, waveforms of the laser light output) for a case where the length of pre-written data is 3T, as an example of the case where the length of pre-written data is long, and a case where the length of pre-written data is 1T, as an example of the case where the length of pre-written data is short. The relationship between the specific numerical values of the length of pre-written data and the output of laser light is not limited to the above. In a case where the length of pre-written data is a first length, the output of laser light can be set as desired as long as the output of laser light is set to be higher as compared with a case where the length of the pre-written data is a second length that is longer than the first length.

As described above, the processing circuit 50e changes the output of laser light at the time of writing “0” depending on the length of pre-written data immediately before the writing of “0”, namely, the number of consecutive digit regions DG including the digit region DG as the write destination of “0” in the same state as the state of the digit region DG of the write destination of “0” of the +1 state, the −1 state, or the 0 state immediately before the writing of “0”. More specifically, considering from the perspective of the number of consecutive digit regions DG including the digit region DG as the write destination of “0” in the same state as the state of the digit region DG as the write destination of “0” of the +1 state, the −1 state, or the 0 state immediately before the write of “0”, the processing circuit 50e increases the output of laser light in a case where the number of the consecutive digit regions DG is a third number as compared with a case where the number of the consecutive digit regions DG is a fourth number that is greater than the third number.

As a result, deterioration of the fluctuation in the amplitude of the reproduction signal due to the length of the pre-written data is suppressed. As a result, deterioration of the bit error rate due to the length of the pre-written data is suppressed.

### Fourth Embodiment

As described above, when the amplitude of the recording current corresponding to the 0 state is set to exactly zero during a write operation, the magnetization state of the target digit region will be determined by thermal noise or the induced magnetic field from surrounding digit regions. This induced magnetic field from the surrounding digit regions includes the influence of a demagnetizing field from the digit region through which the magnetic head passes immediately before the consecutive digit regions to which “0” is written. That is, in the consecutive digit regions to which “0” is written, a polarity opposite to a polarity of the digit region where the magnetic head passes immediately before the consecutive digit regions to which “0” is written is induced. Hereinafter, the digit region through which the magnetic head passes immediately before the consecutive digit regions to which “0” is written will be referred to as a preceding adjacent digit region.

Due to the influence of the demagnetizing field from the preceding adjacent digit region, there is a possibility that the underlying data cannot be completely erased when writing “0”. In other words, the stability of the state in which “0” is written may be insufficient.

In the fourth embodiment, when writing “0”, the processing circuit 50 (referred to as processing circuit 50f) supplies a minute recording current to the write element 22w with the same sign as the recording current when writing to the preceding adjacent digit region DG. As a result, when writing “0”, the write element 22w generates a magnetic field that cancels out the demagnetizing field from the preceding adjacent digit region DG. It is possible to erase the underlying data without being affected by the demagnetizing field from the preceding adjacent digit region DG. As a result, the state in which “0” is written can be stabilized.

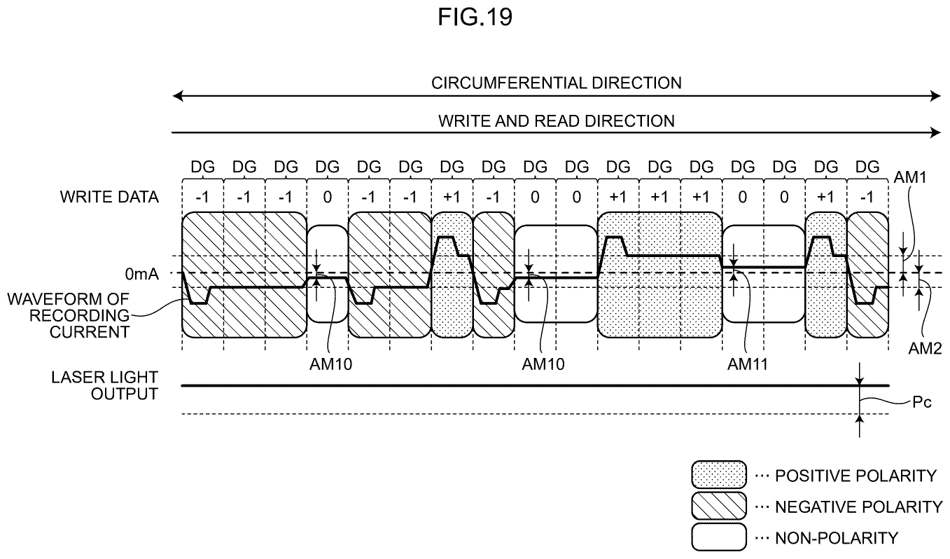

FIG. 19 is a diagram for describing a specific example of the recording method according to the third embodiment.

In the example illustrated in FIG. 19, the amplitude of the recording current corresponding to the +1 state is set to a value AW1, and the amplitude of the recording current corresponding to the −1 state is set to a value AW2. A recording current with an amplitude of these values achieves saturation magnetic recording.

On the other hand, the amplitude of the recording current corresponding to the 0 state is set to a value AW10 or AW11. Each of the values AW10 and AW11 is smaller than both the values AW1 and AW2 and is non-zero.

When the processing circuit 50f supplies a positive recording current with an amplitude of the value AW1 to the write element 22w when writing to the preceding adjacent digit region DG, in other words, when writing “+1” to the preceding adjacent digit region DG, it supplies a positive recording current with an amplitude of the value AW11 to the write element 22w when writing “0”.

When the processing circuit 50f supplies a negative recording current with an amplitude of the value AW2 to the write element 22w when writing to the preceding adjacent digit region DG, in other words, when writing “−1” to the preceding adjacent digit region DG, it supplies a negative recording current with an amplitude of the value AW10 to the write element 22w when writing “0”.

The amount of recording current of which the sign is positive and of which the amplitude has the value AW11 is an example of an eighth value. The amount of recording current of which the sign is negative and of which the amplitude has the value AW10 is an example of a ninth value. That is, according to the fourth embodiment, the recording current having the amplitude of the sixth value includes the recording current having the amplitude of the eighth value and the recording current having the amplitude of the ninth value.

More specifically, when the processing circuit 50f writes “+1” to the preceding adjacent digit region DG and then writes “0”, it supplies a positive recording current of the eighth value to the write element 22w when writing the “0”. When the processing circuit 50f writes “−1” to the preceding adjacent digit region DG and then writes “0”, it supplies a negative recording current of the ninth value to the write element 22w when writing the “0”.

Therefore, the state in which “0” is written can be stabilized. In other words, signals that can take three or more levels can be written to the magnetic disk in an appropriate manner.

### Sixth Modification

It is believed that the influence of the demagnetizing field from the preceding adjacent digit region DG becomes greater the longer the length (hereinafter referred to as the length of the preceding adjacent data) of the consecutive digit regions DG including the preceding adjacent digit region DG that is in the same state as the state of the preceding adjacent digit region DG, either the +1 state or the −1 state. Therefore, the processing circuit 50f may be configured to vary the recording current when writing “0” depending on the length of the preceding adjacent data.

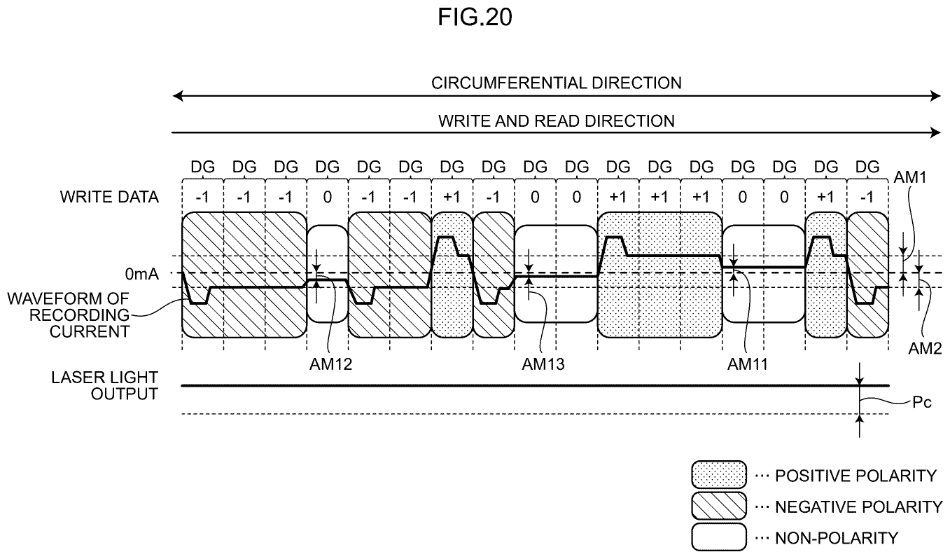

FIG. 20 is a diagram for describing a specific example of a recording method according to a sixth modification. In the example illustrated in this figure, when writing “−1” to the preceding adjacent digit region DG and then writing “0”, and the length of the preceding adjacent data is 3T, the processing circuit 50f supplies a negative recording current with an amplitude of AM12 to the write element 22w when writing the “0”. In the case where “−1” is written to the preceding adjacent digit region DG and then “0” is written, and the length of the preceding adjacent data is 1T, the processing circuit 50f supplies a negative recording current with an amplitude of AM13 to the write element 22w when writing the “0”. AM13 is smaller than AM12.

That is, the shorter the length of the preceding adjacent data, the smaller the amplitude the processing circuit 50f makes when writing “0”. In the example illustrated in FIG. 20, when writing “−1” to the preceding adjacent digit region DG and then writing “0”, the amplitude when writing “0” is made different depending on the length of the preceding adjacent data. Similarly, when writing “0” after writing “+1” to the preceding adjacent digit region DG, the processing circuit 50f varies the amplitude when writing “0” depending on the length of the preceding adjacent data.

The value of the amplitude of the recording current corresponding to the 0 state that can minimize the bit error rate can be influenced by various factors in addition to the demagnetizing field from the preceding adjacent digit region DG. Therefore, for the amplitude of the recording current corresponding to the 0 state, an optimum value is searched for, for example, during the manufacturing process, and the value obtained by the search is determined as the amplitude of the recording current corresponding to the 0 state.

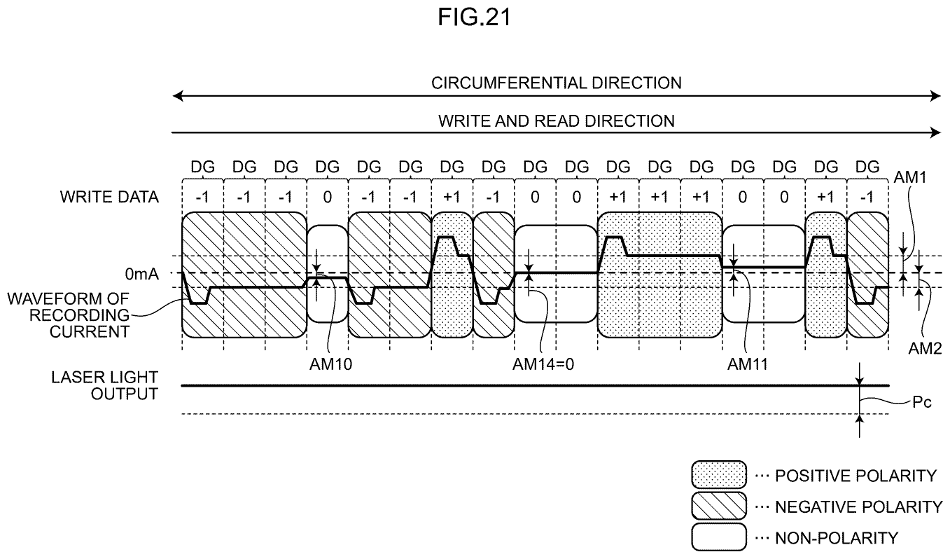

FIG. 21 is a diagram for describing another specific example of the recording method according to the sixth modification. When the length of the preceding adjacent data is short (for example, when the length of the preceding adjacent data is 1T), the influence of the demagnetizing field from the preceding adjacent digit region DG can be considered to be negligibly small. In such a case, as illustrated in FIG. 21, when the length of the preceding adjacent data is 1T, the processing circuit 50f may set the recording current to zero when writing “0”.

In this way, the processing circuit 50f may be configured to vary the recording current when writing “0” depending on the length of the preceding adjacent data.

Furthermore, when the length of the preceding adjacent data is a first specific value (for example, 1T), the processing circuit 50f may set the recording current supplied to the write element 22w to zero when writing “0”.

### Seventh Modification

In one or more consecutive digit regions DG in which “0” is written, the influence of the demagnetizing field from the preceding adjacent digit region DG is attenuated according to a distance to the preceding adjacent digit region DG. Therefore, according to a seventh modification, while the magnetic head 22 passes through a predetermined section where it is strongly influenced by the demagnetizing field from the preceding adjacent digit region DG after passing through a boundary between the preceding adjacent digit region DG and the digit region DG where “0” is written, the processing circuit 50f supplies a recording current of non-zero amplitude to the write element 22w. After the magnetic head 22 has passed through this section, the processing circuit 50f reduces the recording current supplied to the write element 22w to zero.

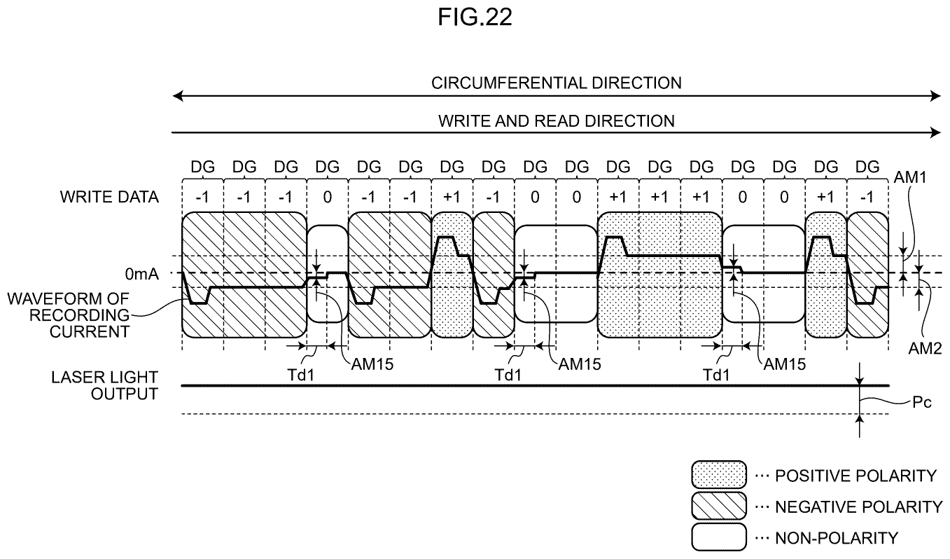

FIG. 22 is a diagram for describing a specific example of a recording method according to a seventh modification. As illustrated in this figure, when writing “0”, the processing circuit 50f supplies a recording current with an amplitude of AW15 and positive or negative sign to the write element 22w for a time Td1 after the start of writing “0”. However, the value AW15 is smaller than both the value AW1 and the value AW2, and is a non-zero value. When “0” is written after “+1” has been written to the preceding adjacent digit region DG, the sign of the recording current with the amplitude of AM15 supplied to the write element 22w is positive. When “−1” is written to the preceding adjacent digit region DG and then “0” is written, the sign of the recording current with the amplitude of AM15 supplied to the write element 22w is negative.

When the time Td1 has elapsed since the start of writing “0”, the processing circuit 50f reduces the recording current supplied to the write element 22w to zero.

The time Td1 corresponds to the time required for the magnetic head 22 to pass through the predetermined section where the magnetic head 22 is strongly affected by the demagnetizing field. With the above-described configuration, writing of “0” is implemented while canceling the influence of the demagnetizing field from the preceding adjacent digit region DG only while the magnetic head 22 passes through the section where it is strongly influenced by the demagnetizing field. The time Td1 is an example of a first time length.

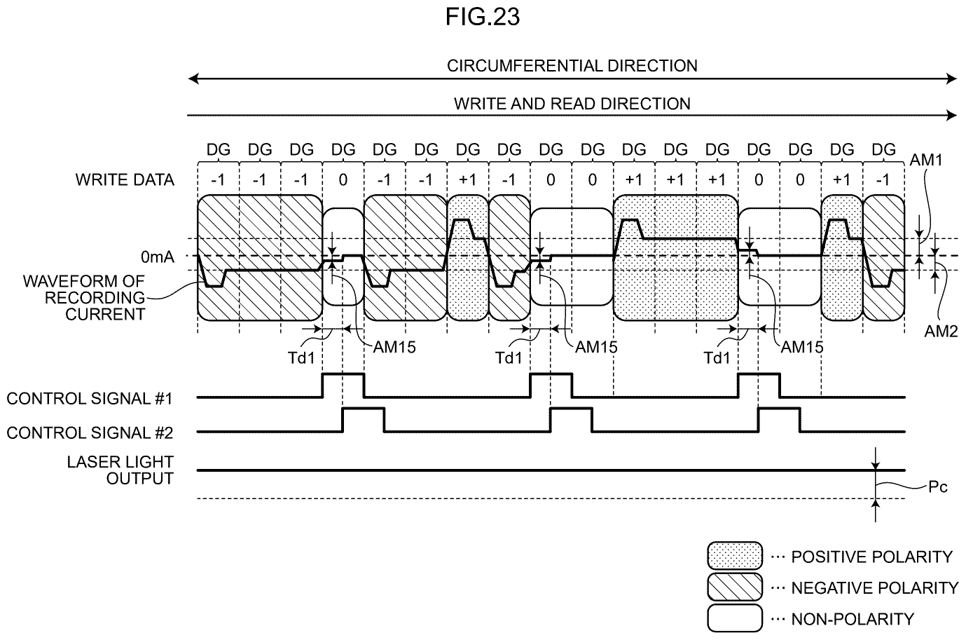

FIG. 23 is a diagram for describing an example of a configuration for implementing a recording method according to the seventh modification. In the example illustrated in this figure, the processing circuit 50f can control the above-described recording current using two control signals (control signal #1 and control signal #2). In the processing circuit 50f, the RWC 25 uses the control signal #1 to instruct the preamplifier 24 on the timing of writing “0”. Furthermore, the RWC 25 generates the control signal #2 by shifting the phase of the control signal #1. The RWC 25 shifts the phase of the control signal #1 by an amount corresponding to the time Td1 and transmits the resulting signal as the control signal #2 to the preamplifier 24.

At a rising edge of the control signal #1, the preamplifier 24 starts supplying a recording current with the amplitude of AW15 and positive or negative sign to the write element 22w. Furthermore, the preamplifier 24 reduces the recording current supplied to the write element 22w to zero at the rising edge of the control signal #1.

With the above configuration, a designer can continuously change the time Td1 by setting the amount of phase shift between the control signal #1 and the control signal #2. The amount of phase shift between the control signal #1 and the control signal #2 may be set as a parameter by the designer, or may be changed by the SoC 30 (for example, processor 26).

The configuration for implementing the recording method according to the seventh modification is not limited to the above-described example. The preamplifier 24 may be configured to include a timer, and to measure the time Td1 after the start of writing “0” using the timer.

In the description of the seventh modification, the amplitude of the recording current at the start of writing “0” is set to the value AW15. As in the sixth modification, the amplitude of the recording current at the start of writing “0” can be changed in various ways. Also, the amplitude of the recording current at the start of writing “0” can be made different depending on the polarity of the preceding adjacent digit region DG, as in the fourth embodiment.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A magnetic disk device comprising:
a magnetic disk comprising a track including a plurality of unit recording regions arranged in a line in a circumferential direction;
a magnetic head comprising a write element that writes data to the track and a light emitting element that irradiates a write position by the write element on the magnetic disk with laser light; and
a processing circuit capable of executing any write operation of a first write operation of writing a first value in a first unit recording region that is one unit recording region among the plurality of unit recording regions, a second write operation of writing a second value different from the first value in the first unit recording region, and a third write operation of writing a third value different from both the first value and the second value in the first unit recording region, the first write operation being an operation of bringing a magnetization state of the first unit recording region to a first state by supplying a positive recording current having an amplitude of a fourth value to the write element while causing the light emitting element to output the laser light, the second write operation being an operation of bringing the magnetization state of the first unit recording region to a second state different from the first state by supplying a negative recording current having an amplitude of a fifth value to the write element while causing the light emitting element to output the laser light, the third write operation being an operation of bringing the magnetization state of the first unit recording region to a third state different from both the first state and the second state by supplying a recording current including a recording current having an amplitude of a sixth value to the write element, the sixth value being a non-zero value smaller than those of both the fourth value and the fifth value, while causing the light emitting element to output the laser light.

2. The magnetic disk device according to claim 1, wherein
the processing circuit supplies, in the third write operation, to the write element a recording current having a preset sign of either positive or negative sign and an amplitude of the sixth value.

3. The magnetic disk device according to claim 2, wherein
the processing circuit changes output of the laser light in the third write operation depending on a number of consecutive unit recording regions in which the third value is to be written, the consecutive unit recording regions including the first unit recording region.

4. The magnetic disk device according to claim 3, wherein
the processing circuit increases output of the laser light in a case where the number of consecutive unit recording regions in which the third value is to be written is a first number, the consecutive unit recording regions including the first unit recording region, as compared with a case where the number of consecutive unit recording regions in which the third value is to be written is a second number greater than the first number, the consecutive unit recording regions including the first unit recording region.

5. The magnetic disk device according to claim 2, wherein
the processing circuit changes output of the laser light in the third write operation depending on a number of consecutive unit recording regions that is in a same state as a state of the first unit recording region among the first state, the second state, and the third state immediately before the third write operation, the consecutive unit recording regions including the first unit recording region.

6. The magnetic disk device according to claim 5, wherein
the processing circuit increases output of the laser light in a case where the number of consecutive unit recording regions is a third number as compared with a case where the number of consecutive unit recording regions is a fourth number greater than the third number.

7. The magnetic disk device according to claim 2, wherein
the processing circuit sets the amplitude of the recording current to the sixth value at timing earlier than timing at which the write element reaches the first unit recording region when executing the third write operation on the first unit recording region immediately after executing the first write operation or the second write operation on a second unit recording region, and
the second unit recording region is a unit recording region through which the magnetic head passes immediately before the first unit recording region among the plurality of unit recording regions.

8. The magnetic disk device according to claim 1, wherein
the recording current having the amplitude of the sixth value supplied to the write element in the third write operation includes a plurality of recording currents of seventh values.

9. The magnetic disk device according to claim 8, wherein
the plurality of recording currents of seventh values include a positive recording current of an eighth value and a negative recording current of a ninth value.

10. The magnetic disk device according to claim 9, wherein
the processing circuit
supplies the positive recording current of the eighth value to the write element in the third write operation when the third write operation is executed on the first unit recording region after the first write operation is executed on a second unit recording region, and
supplies the negative recording current of the ninth value to the write element in the third write operation when the third write operation is executed on the first unit recording region after the second write operation is executed on the second unit recording region, and
the second unit recording region is a unit recording region through which the magnetic head passes immediately before the first unit recording region among the plurality of unit recording regions.

11. The magnetic disk device according to claim 10, wherein
the processing circuit
sets the recording current supplied to the write element to zero in the third write operation when the number of consecutive unit recording regions including the second unit recording region in the same state as a state of the second unit recording region is a tenth value, and
supplies the positive recording current of the eighth value or the negative recording current of the ninth value to the write element in the third write operation when the number of consecutive unit recording regions including the second unit recording region in the same state as the state of the second unit recording region is an eleventh value greater than the tenth value.

12. The magnetic disk device according to claim 9, wherein
the processing circuit
supplies the positive recording current of the eighth value or the negative recording current of the ninth value to the write element for a first time length in the third write operation, after start of the third write operation, and
sets the recording current supplied to the write element to zero in the third write operation, after the first time length elapses since the start of the third write operation.

13. The magnetic disk device according to claim 1, wherein
the recording current supplied to the write element in the third write operation includes a positive recording current, a negative recording current, and a zero recording current.

14. The magnetic disk device according to claim 13, wherein
the processing circuit
varies the recording current supplied to the write element in the third write operation depending on the number of consecutive unit recording regions including the second unit recording region that is in a same state as a state of the second unit recording region, and
the second unit recording region is a unit recording region through which the magnetic head passes immediately before the first unit recording region among the plurality of unit recording regions.

15. A method of controlling a magnetic disk device comprising: a magnetic disk comprising a track including a plurality of unit recording regions arranged in a line in a circumferential direction; and a magnetic head comprising a write element that writes data to the track and a light emitting element that irradiates a write position by the write element on the magnetic disk with laser light, the method comprising
executing any write operation of a first write operation of writing a first value in a first unit recording region that is one unit recording region among the plurality of unit recording regions, a second write operation of writing a second value different from the first value in the first unit recording region, and a third write operation of writing a third value different from both the first value and the second value in the first unit recording region, wherein
the first write operation is an operation of bringing a magnetization state of the first unit recording region to a first state by supplying a positive recording current having an amplitude of a fourth value to the write element while causing the light emitting element to output the laser light,
the second write operation is an operation of bringing the magnetization state of the first unit recording region to a second state different from the first state by supplying a negative recording current having an amplitude of a fifth value to the write element while causing the light emitting element to output the laser light, and
the third write operation is an operation of bringing the magnetization state of the first unit recording region to a third state different from both the first state and the second state by supplying a recording current including a recording current having an amplitude of a sixth value to the write element, the sixth value being a non-zero value smaller than those of both the fourth value and the fifth value, while causing the light emitting element to output the laser light.

16. The method according to claim 15, comprising
supplying, to the write element, a recording current having a preset sign of either positive or negative sign and the amplitude of the sixth value, in the third write operation.

17. The method according to claim 16, further comprising
changing output of the laser light in the third write operation depending on a number of consecutive unit recording regions in which the third value is to be written, the consecutive unit recording regions including the first unit recording region.

18. The method according to claim 15, wherein
the recording current having the amplitude of the sixth value supplied to the write element in the third write operation includes a plurality of recording currents of seventh values.

19. The method according to claim 18, wherein
the plurality of recording currents of the seventh values include a positive recording current of an eighth value and a negative recording current of a ninth value.

20. The method according to claim 19, further comprising:
supplying the positive recording current of the eighth value to the write element in the third write operation when the third write operation is executed on the first unit recording region after the first write operation is executed on a second unit recording region; and
supplying the negative recording current of the ninth value to the write element in the third write operation when the third write operation is executed on the first unit recording region after the second write operation is executed on the second unit recording region, wherein
the second unit recording region is a unit recording region through which the magnetic head passes immediately before the first unit recording region among the plurality of unit recording regions.
